(19) United States
(12) Patent Application Publication
(10) Pub. No.: US 2006/0047027 A1
(43) Pub. Date: Mar. 2, 2006

(54) Well treatment fluids containing a multimodal polymer system

(76) Inventors: Harold D. Brannon, Magnolia, TX (US); Robert M. Tjon-Joe Pin, Houston, TX (US)

Correspondence Address: HOWREY LLP, C/O IP DOCKETING DEPARTMENT, 2941 FAIRVIEW PARK DRIVE, SUITE 200, FALLS CHURCH, VA, 22042-7195, US

(21) Appl. No.: 10/924,415

(22) Filed: Aug. 24, 2004

(51) Int. Cl. C08L 5/00

(52) U.S. Cl. 524/27; 524/36; 524/43; 524/45

(57) ABSTRACT

Well treatment fluids containing a multimodal polymer mixture are disclosed, as are methods for their use. The fluids can contain a fluid, a polymer mixture, and a crosslinking agent. The polymer mixture has a multimodal molecular weight distribution such as a bimodal distribution, a trimodal distribution, or a tetramodal distribution. The polymer mixture can be a mixture of the same polymer, where different batches of different molecular weight distributions are combined. Alternatively, the polymer mixture can be a mixture of different polymers having different molecular weight distributions.

### FIELD OF THE INVENTION

The invention relates to methods and compositions for treating subterranean formations. More particularly, well treatment fluids containing a multimodal polymer system, and methods for their use in treating oil and/or gas wells are disclosed.

### DESCRIPTION OF RELATED ART

Subterranean formations in oil and gas wells are often treated to improve their production rates. Hydraulic fracturing operations can be performed, wherein a viscous fluid is injected into the well under pressure which causes cracks and fractures in the well. This, in turn, can improve the production rates of the well. Proppant materials are commonly included with the fluid in order to prevent the fractures from collapsing once the hydraulic fracturing operation is complete.

Fracturing fluids containing water and biodegradable polymers can be treated with an appropriate chemical agent or enzyme to effect breaking of the fluid. Alternatively, changes in conditions (e.g. temperature or pH) can be used to effect breaking of the fluid. The polymers are frequently crosslinked with metal ions such as borate, titanate, or zirconate salts. Polymers such as guar, guar derivatives, galactomannans, cellulose, and cellulose derivatives (e.g. hydroxypropyl guar and hydroxyethyl cellulose) can be used.

Examples of well treatments in which metal-crosslinked polymers are used are hydraulic fracturing, gravel packing operations, water blocking, and other well completion operations.

One difficulty encountered has been that the viscous nature of the fluid, while desirable during the fracturing step, increases the difficulty of its removal from the well after fracturing. Ideally, the viscosity of the fluid is reduced after the hydraulic fracturing in order to facilitate the fluid's removal from the well. This reduction in viscosity is commonly referred to as “breaking” of the fluid. Various methods of breaking have been reported in patents and in the technical literature.

U.S. Pat. No. 4,477,360 (issued Oct. 16, 1984) suggests the use of an aqueous gel containing a zirconium salt and a polyhydroxyl-containing compound. The gel is suggested for use in fracturing fluids, and has a high viscosity. The polyhydroxyl compounds have 3 to 7 carbon atoms, and a preferred compound is glycerol. Gelling agents include various polysaccharides.

U.S. Pat. No. 4,635,727 (issued Jan. 13, 1987) offers methods of fracturing a subterranean formation using a base guar gum gel and a crosslinking system. A preferred crosslinking system includes zirconium lactate and aluminum chlorohydrate.

U.S. Pat. No. 5,305,832 (issued Apr. 26, 1994) proposes methods for using crosslinked guar polymers at a pH such that the cationic charge density of the polymer is at its maximum. The pH is chosen to minimize thermal degradation and to minimize polymer gel loading. The pH varied depending on the polymer used, but were typically in the range of about 10 to about 12.

U.S. Pat. No. 5,547,026 (issued Aug. 20, 1996) offers a blocking gel formed by blending a hydrated polymer solution with a selected polymer in an unhydrated particulate form. The gel can also contain a crosslinking agent and a breaking agent. The blocking gel is attractive, as it allows mixing and pumping at low viscosity which minimizes friction pressures.

U.S. Pat. No. 5,972,850 (issued Oct. 26, 1999) offers an aqueous metal hydrated galactomannan gum buffered to pH 9 to 11, and methods for its use in fracturing a subterranean formation. Metal ions suggested to crosslink the galactomannan gum include boron, zirconium, and titanium ions.

U.S. Pat. No. 6,017,855 (issued Jan. 25, 2000) suggests methods for fracturing subterranean formations using fluids having reduced polymer loadings. The fluids contain modified polymers having randomly distributed anionic substituents. The polymers can be crosslinked to form viscous gels that are stable at low polymer concentrations. Modification of the polymers lead to lowered C* concentrations (the concentration necessary to cause polymer chain overlap).

U.S. Pat. No. 6,060,436 (issued May 9, 2000) proposes the use of borate ion crosslinked galactomannan gums in fracturing fluids. The crosslinking is delayed by release of borate ions from a polyol complex.

U.S. Patent Publication No. 20030045708 A1 (published Mar. 6, 2003) suggests methods for depolymerizing galactomannan and its derivatives. Compositions containing the depolymerized galactomannans are also described having particular polydispersity indices, weight average molecular weights (Mw), and viscosities. The compositions are suggested to be useful as a component of a hydraulic fracturing fluid.

SPE 29446 (1995) discusses field results of well treatment with borate-crosslinked or titanate-crosslinked systems. Performance was observed to improve with the following treatments, in increasing order of improvement: titanate-crosslinked fluids, borate-crosslinked fluids, organoborate-crosslinked fluids, and organoborate-crosslinked fluids with a guar-specific enzyme breaker. Organoborates were offered as providing stronger crosslink junctions, greater elasticity, high viscosity, and reduced polymer loadings.

SPE 36496 (1996) offers the characterization of breaker efficiency by determining the size distribution of degraded polymer fragments. Reduced viscosity was discussed as not being fully indicative of molecular weight reduction. For example, the use of oxidative breakers is capable of reducing gel viscosity, but is relatively ineffective to reduce the polymer molecular weight. Guar specific enzymes were found to provide the most efficient molecular weight reduction of crosslinked fluids.

Despite progress made to date, there still exists a need for methods and compositions useful for treating oil and gas wells.

### SUMMARY OF THE INVENTION

Embodiments of the instant invention are generally directed towards fracturing fluids and methods for their use. Fracturing fluids disclosed herein comprise a liquid, a polymer soluble in the liquid, and a crosslinking agent capable of increasing the viscosity of the fracturing fluid by crosslinking the polymer in liquid. The polymer has a multi-modal molecular weight distribution. Multi-modal distributions include bimodal, trimodal, and so on.

### DESCRIPTION OF THE FIGURES

The following figures form part of the present specification and are included to further demonstrate certain aspects of the present invention. The invention may be better understood by reference to one or more of these figures in combination with the detailed description of specific embodiments presented herein.

FIG. 1 shows the shear rate vs. viscosity plot for low molecular weight guar and high molecular weight guar compositions. The x-axis is shear rate in sec⁻¹ ; the y-axis is viscosity in cps.

FIG. 2 shows viscosity vs. total polymer loading for two different molecular weight polymers individually and in combination. The x-axis is combined polymer loading in lb/Mgal; the y-axis is viscosity at 511 sec⁻¹ in cps.

FIG. 3 shows the normalized linear gel viscosity of mono-modal and bi-modal polymer compositions. The x-axis is the sample number; the y-axis is linear gel viscosity normalized relative to sample 4.

FIG. 4 shows vortex closure times of mono-modal and bi-modal polymer compositions having combined polymer concentrations of 40 lb/Mgal. The x-axis is the sample number; the y-axis is the vortex closure time in seconds.

FIG. 5 shows vortex closure times of mono-modal and bi-modal polymer compositions having combined polymer concentrations of 50 lb/Mgal. The x-axis is the sample number; the y-axis is the vortex closure time in seconds.

FIG. 6 shows vortex closure times of mono-modal and bi-modal polymer compositions having combined polymer concentrations of 60 lb/Mgal. The x-axis is the sample number; the y-axis is the vortex closure time in seconds.

FIG. 7 shows the normalized elastic and viscous moduli of mono-modal and bi-modal polymer compositions. The x-axis is the sample number; the y-axis is elastic modulus (shaded) and viscous modulus (unshaded) normalized relative to sample 4.

FIG. 8 shows the vortex closure time of monomodal and bimodal polymer mixtures. The x-axis is the sample number; the y-axis is the vortex closure time in seconds.

FIG. 9 shows the viscosity of monomodal and bimodal polymer mixtures after heating. The x-axis is the sample number; the y-axis is the viscosity at 40 sec⁻¹ in cps.

FIG. 10 shows the viscosity of monomodal and bimodal polymer mixtures after heating. The x-axis is the sample number; the y-axis is the viscosity at 40 sec⁻¹ in cps.

FIG. 11 shows the viscosity of monomodal and bimodal polymer mixtures after heating. The x-axis is the sample number; the y-axis is the viscosity at 40 sec⁻¹ in cps.

FIG. 12 shows the viscosity of monomodal and bimodal polymer mixtures after heating. The x-axis is the sample number; the y-axis is the viscosity at 40 sec⁻¹ in cps.

FIG. 13 shows the change in viscosity over time of monomodal and bimodal compositions held at high temperature. The x-axis is time in minutes; the y-axis is viscosity at 100 sec⁻¹ in cps.

FIG. 14 shows the change in viscosity over time of monomodal and bimodal compositions held at high temperature. The x-axis is time in seconds; the y-axis is viscosity at 100 sec⁻¹ in cps.

FIG. 15 shows the change in viscosity over time of monomodal and bimodal compositions held at high temperature. The x-axis is time in minutes; the y-axis is viscosity at 100 sec⁻¹ in cps.

FIG. 16 shows the change in viscosity over time of monomodal and bimodal compositions held at high temperature. The x-axis is time in minutes; the y-axis is viscosity at 100 sec⁻¹ in cps.

FIG. 17 shows the change in viscosity over time of monomodal and bimodal compositions held at high temperature. The x-axis is time in minutes; the y-axis is viscosity at 100 sec⁻¹ in cps.

FIG. 19 shows the change in viscosity over time of monomodal and bimodal compositions held at high temperature. The x-axis is time in minutes; the y-axis is viscosity at 100 sec⁻¹ in cps.

FIG. 20 shows the typical behavior of a fracturing operation. The round symbols represent cumulative pump time; the diamond symbols represent shear rate; the square symbols represent friction pressure; and the diamond symbols represent the ideal viscosity profile.

FIG. 21 shows a comparison of monomodal and bimodal polymer mixtures as fracturing fluids. The unshaded round symbols represent cumulative pump time; the diamond symbols represent shear rate; the shaded square symbols represent friction pressure; the triangle symbols represent the ideal viscosity profile; the crossed square symbols represent high molecular weight monomodal polymer system; the shaded round symbols represent low molecular weight monomodal polymer system; and the unshaded square symbols represent the bimodal polymer system.

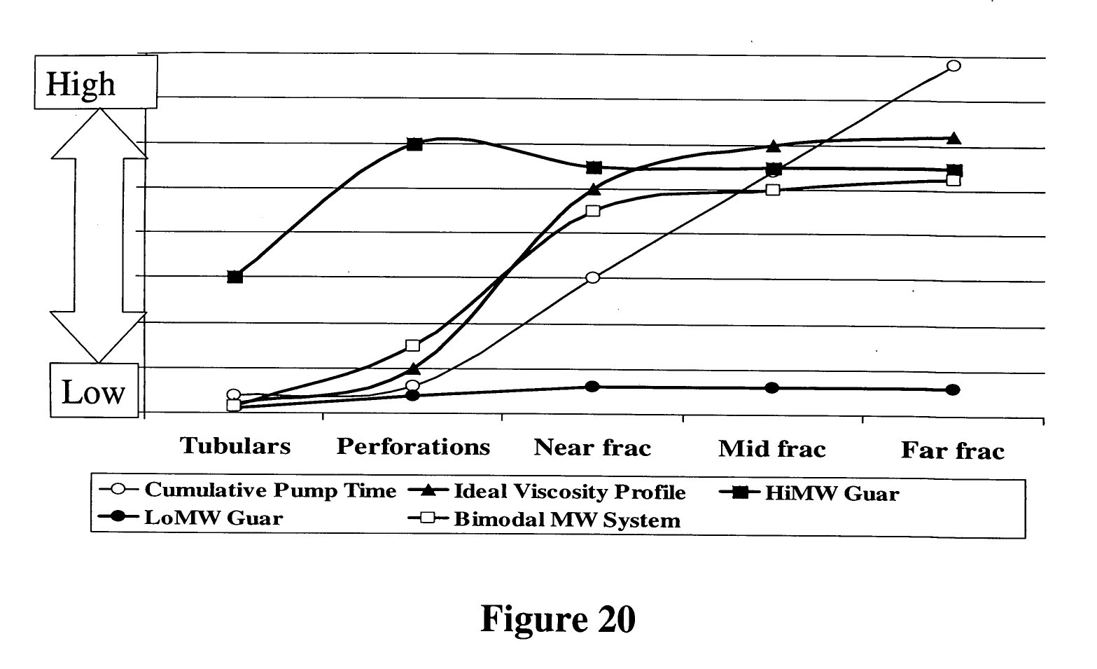

### DETAILED DESCRIPTION OF THE INVENTION

Embodiments of the invention provide well stimulation fluids and methods of making and using the well stimulation fluids to treat subterranean formations. The well stimulation fluids can be used in hydraulic fracturing applications and for applications other than hydraulic fracturing, such as gravel packing operations, water blocking, temporary plugs for purposes of wellbore isolation and/or fluid loss control, etc. Most fracturing fluids are aqueous based, although non-aqueous fluids may also be formulated and used.

While compositions and methods are described in terms of “comprising” various components or steps (interpreted as meaning “including, but not limited to”), the compositions and methods can also “consist essentially of” or “consist of” the various components and steps, such terminology should be interpreted as defining essentially closed-member groups.

Compositions

One embodiment of the invention is directed towards fracturing fluids comprising a liquid, a polymer soluble in the liquid, and a crosslinking agent capable of increasing the viscosity of the fracturing fluid by crosslinking the polymer in liquid. The polymer has a multi-modal molecular weight distribution. The polymer can be a single polymer having a multi-modal molecular weight distribution, or can be a mixture of multiple polymers, each having different molecular weight distributions, that when combined, gives a multi-modal molecular weight distribution.

The “modality” of a molecular weight distribution can be determined by a variety of methods, such as size exclusion chromatography or gel permeation chromatography. Typically, a two-dimensional graph is generated, with the molecular weight being plotted on the x-axis, and the concentration or population being plotted on the y-axis. The molecular weight can be represented in a variety of manners such as number average molecular weight or weight average molecular weight. Unless otherwise specified, molecular weight refers to weight average molecular weight. A mono-modal molecular weight distribution would appear when plotted as a single peaked curve. The single peaked curve can be symmetric, or more typically, can be asymmetric. Multi-modal molecular weight distributions would appear as the sums of multiple non-identical mono-modal distributions. Multi-modal molecular weight distributions can include bi-modal, tri-modal, tetra-modal, penta-modal, and so on. In other words, the number of peaks can be 2, 3, 4, 5, 6, 7, 8, and so on. If the plot is not smooth, minor irregularities can be “smoothed” by generally any mathematically valid model.

The liquid can generally be any liquid in which the respective polymers will solubilize. A presently preferred liquid is water, or an aqueous solution. The aqueous solution can comprise various salts, solvents (e.g. alcohols), polymers, polysaccharides, or other materials. The aqueous solution can further comprise suspended or dispersed materials. The liquid can also be an alcohol or other solvent miscible with water. Examples of alcohols include methanol, ethanol, 1-propanol, and 2-propanol. The liquid can be a mixture of water and a solvent.

An aqueous fracturing fluid may be prepared by blending a hydratable or water-dispersible polymer with an aqueous fluid. The aqueous fluid can be, for example, water, brine, or water-alcohol mixtures. Any suitable mixing apparatus may be used for this procedure. In the case of batch mixing, the hydratable polymer and aqueous fluid are blended for a period of time which is sufficient to form a hydrated sol.

Polymers can contain neutral groups, anionic groups, cationic groups, or combinations thereof. Suitable anionic groups include carboxylate groups, carboxyalkyl groups, carboxyalkyl hydroxyalkyl groups, sulfate groups, sulfonate groups, amino groups, amide groups, or any combination thereof. An alkyl group includes any hydrocarbon radical, such as methyl, ethyl, propyl, butyl, pentyl, hexyl, heptyl, octyl, etc.

Suitable cationic groups include quaternary ammonium groups. Examples of quaternary ammonium groups include methylene trimethylammonium chloride, methylene trimethylammonium bromide, benzyltrimethylammonium chloride and bromide, ethylene triethylammonium chloride, ethylene triethylammonium bromide, butylene tributylammonium chloride, butylene tributylammonium bromide, methylenepyridinium chloride, methylenepyridinium bromide, benzylpyridinium chloride, benzylpyridinium bromide, methylene dimethyl-p-chlorobenzylammonium chloride, methylene dimethyl-p-chlorobenzylammonium bromide, and the like, wherein each of the groups is derivatized in the form of a radical which is substituted in a hydrocolloid gelling agent by means of an alkylene or oxyalkylene linkage. Exemplary cationic polymers are polygalactomannan gums containing quaternary ammonium ether substituents as described in U.S. Pat. No. 4,031,307.

Cationic derivatives of guar gum or locust bean gum can be prepared, for example, by contacting solid guar gum or locust bean gum with a haloalkyl-substituted quaternary ammonium compound and a stoichiometric excess of alkali metal hydroxide or ammonium hydroxide in a reaction medium comprising an aqueous solution of water-miscible solvent, at a temperature of about 10° C. and about 100° C. for a reaction period sufficient to achieve a degree of substitution by quaternary ammonium ether groups between about 0.01 and about 0.1. The solid guar gum or other polygalactomannan which is etherified can be in the form of endosperm splits or in the form of finely divided powder which is derived from the endosperm splits. Preferably, the polygalactomannan gum which is etherified with quaternary ammonium groups should remain as a solid phase in the reaction medium during the reaction period.

Examples of commercially available polygalactomannans with one or more substituted cationic quaternary ammonium groups include Jaguar C-13, Jaguar C-13S, Jaguar C-14, Jaguar C-17 and Jaguar C-14S (all commercially available by Rhodia Inc.). Other suitable cationic polymers include those which contain other cationic groups such as acid salts of primary, secondary, and tertiary amines, sulfonium groups or phosphonium groups. Additional suitable cationic polymers are disclosed in U.S. Pat. Nos. 5,552,462 and No. 5,957,203.

Suitable hydratable polymers that may be used in embodiments of the invention include any of the hydratable polysaccharides which are capable of forming a gel in the presence of a crosslinking agent and have anionic groups to the polymer backbone. For instance, suitable hydratable polysaccharides include anionically substituted galactomannan gums, guars, and cellulose derivatives. Specific examples are anionically substituted guar gum, guar gum derivatives, locust bean gum, Karaya gum, carboxymethyl cellulose, carboxymethyl hydroxyethyl cellulose, and hydroxyethyl cellulose substituted by other anionic groups. More specifically, suitable polymers include carboxymethyl guar, carboxyethyl guar, carboxymethyl hydroxypropyl guar, and carboxymethyl hydroxyethyl cellulose. Additional hydratable polymers may also include sulfated or sulfonated guars, cationic guars derivatized with agents such as 3-chloro-2-hydroxypropyl trimethylammonium chloride, and synthetic polymers with anionic groups, such as polyvinyl acetate, polyacrylamides, poly-2-amino-2-methyl propane sulfonic acid, and various other synthetic polymers and copolymers. Moreover, U.S. Pat. No. 5,566,760 discloses a class of hydrophobically modified polymers for use in fracturing fluids. These hydrophobically modified polymers may be used in embodiments of the invention with or without modification. Other suitable polymers include those known or unknown in the art.

Different polymer compositions, each having its own molecular weight distribution, can be combined to afford a multi-modal molecular weight distribution. The combined compositions can be the same chemical polymer (e.g. two different guar compositions can be combined, each having a different molecular weight distribution), or can be different chemical polymers (e.g. a guar composition having a first molecular weight distribution can be combined with a carboxymethylcellulose composition having a second molecular weight distribution).

The polymer (or combined polymers if more than one is present) may be present in the fluid in concentrations ranging from about 0.05% to about 5.0% by weight of the liquid. The polymer can be present at about 0.1%, about 0.2%, about 0.3%, about 0.4%, about 0.5%, about 0.6%, about 0.7%, about 0.8%, about 0.9%, about 1%, about 2%, about 3%, about 4%, about 5%, or at any range between any two of these values. Suitable ranges for the polymer include from about 0.20% to about 0.80% by weight or from about 0.12% to about 0.24% by weight. In some embodiments, about 20 pounds or less of a polymer is mixed with 1000 gallons of an aqueous fluid (2.4 kg per 1000 liters). For example, about 5, about 10, or about 15 pounds of a polymer may be mixed with 1000 gallons of an aqueous fluid (0.6, 1.2, or 1.8 kg per 1000 liters). Under certain circumstances, it is more advantageous to have reduced polymer loading (i.e., a polymer concentration of 0.24 wt. % or less or 20 ppt or less). This is because less damage would occur to a formation if a reduced level of polymers is used in a fracturing fluid. An additional benefit of reduced polymer loading may be increased fracture conductivity. Although it may be beneficial to employ polymers at a reduced level, a fracturing fluid may be formulated at a higher polymer level. For example, about 20 pounds or higher of a polymer may be mixed with 1000 gallons of an aqueous fluid (2.4 kg per 1000 liters). Specifically, about 25 pounds, about 30 pounds, about 35 pounds, about 40 pounds, about 45 pounds, about 50 pounds, about 55 pounds, or about 60 pounds of a polymer may be mixed with 1000 gallons of an aqueous fluid (3, 3.6, 4.2, 4.8, 5.4, 6, 6.6, or 7.2 kg per 1000 liters). In some embodiments, about 65 pounds or more of a polymer may be mixed with 1000 gallons of an aqueous fluid (7.8 kg per 1000 liters).

The cross-linking agent can generally be any cross-linking agent. The cross-linking agent can be a boron-containing compound, such as a borate compound, or an antimony-containing compound.

A suitable crosslinking agent can be any compound that increases the viscosity of the fluid by chemical crosslinking, physical crosslinking, or any other mechanisms. For example, the gellation of a hydratable polymer can be achieved by crosslinking the polymer with metal ions including aluminum, antimony, zirconium, and titanium containing compounds. An example of an antimony crosslinking agent is an alkali pyroantimonate such as potassium pyroantimonate. Other antimony compounds useful as a crosslinking agent are disclosed, for example, in Advanced inorganic Chemistry, pages 382-443, by F. Albert Cotton and Geoffrey Wilkinson, (5^{th} Ed., 1988). Other antimony crosslinking agents may also be used.

One class of suitable crosslinking agents is organotitanates. Another class of suitable crosslinking agents is borates as described, for example, in U.S. Pat. No. 4,514,309. The selection of an appropriate crosslinking agent can depend upon the type of treatment to be performed and the hydratable polymer to be used. The amount of the crosslinking agent used also depends upon the well conditions and the type of treatment to be effected, but is generally in the range of from about 0.0005 to about 0.1 part, more preferably from about 0.002 to about 0.05 part, by weight of the active crosslinking agent per 100 parts by weight of the aqueous fluid. In some applications, the aqueous polymer solution is crosslinked immediately upon addition of the crosslinking agent to form a highly viscous gel. In other applications, the reaction of the crosslinking agent can be retarded so that viscous gel formation does not occur until the desired time.

A preferred class of boron-containing compounds is those capable of providing borate ions in an aqueous solution. One advantage of using a borate cross-linking agent is that the cross-linking is reversible when the pH of the fracturing fluid declines to below about 7.5. Due to the reversibility, the fracturing fluid may be easily removed after a well treatment is completed. Consequently, borate cross-linked fracturing fluids can provide relatively higher fracture conductivity, especially when compared to zirconium cross-linked fracturing fluids under similar conditions.

Industry experience has shown that, under certain conditions, borate ions do not appreciably cross-link highly carboxylated guar polymers, i.e., polymers with a high degree of substitution of carboxylate groups or other anionic groups. However, when the level of anionic substitution or carboxylation is reduced to a degree of substitution of about 0.1 or less, borate ions can effect the cross-linking the polymer to increase the viscosity without significantly adversely affecting the polymer expansion. “Polymer expansion”, disclosed in U.S. Pat. No. 6,017,855, refers to the phenomena that, due to anionic substitution, the polymer chains tend to expand to a larger extent in an aqueous fluid than a polymer without such anionic substitution. As a result of polymer expansion, reduced polymer loading (i.e., a polymer concentration of about 20 ppt or less) may be used in a fracturing fluid but still achieving relatively high viscosity levels. Therefore, the benefits of reduced polymer loading and increased fracture conductivity can be obtained simultaneously, if desired.

Any boron-containing compound which is capable of yielding borate ions in solution may be used in embodiments of the invention. Suitable borates include boric acid, boric oxide, alkali metal borate (e.g., sodium borate or sodium tetraborate), alkaline earth metal borate, or a mixture thereof. Suitable borate compounds include the minerals listed in the following table.

| Name | Chemical formula |
|---|---|
| probertite | NaCaB₅O₉.5H₂0 |
| ulexite | BaCaB₅O₉.8H₂0 |
| nobleite | CaB₆O₁₀.4H₂0 |
| growerite | CaB₆O₁₀.5H₂0 |
| frolovite | CaB₄O₈.7H₂0 |
| colemanite | CaB₆O₁₁.5H₂0 |
| meyerhofferite | CaB₆O₁₁.7H₂0 |
| inyoite | CaB₆O₁₁.13H₂0 |
| priceite | CaB₁₀O₁₉.7H₂0 |
| tertschite | Ca₄B₁₀O₁₉.20H₂0 |
| ginorite | Ca₂B₁₄O₂₃.8H₂0 |
| pinnoite | MgB₂O₄.3H₂0 |
| paternoite | MgB₈O₁₃.4H₂0 |
| kurnakovite | Mg₂B₆O₁₁.15H₂0 |
| inderite | MgB₆O₁₁.15H₂0 |
| preobrazhenskite | Mg₃B₁₀O₁₈.4½H₂0 |
| hydroboracite | CaMgB₆O₁₁.6H₂0 |
| inderborite | CaMgB₆O₁₁.11H₂0 |
| kaliborite | KMg₂B₁₁O₁₉.9H₂0 |
| veatchite | SrB₆O₁₀.2H₂0 |

A suitable borate cross-linking agent may be used in any amount to effect the cross-linking and, thus, to increase the viscosity of a fracturing fluid. The concentration of a borate cross-linking agent generally is dependent upon factors such as the temperature and the amount of the polymer used in a fracturing fluid. Normally, the concentration may range from about 5 ppm to about 500 ppm. A borate cross-linking agent may be used in any form, such as powder, solution, or granule. Encapsulated borates may also be used. Encapsulated borate may be prepared by providing a hydrocarbon-based enclosure member which envelopes a breaking agent. Encapsulation may be accomplished by the method described in U.S. Pat. No. 4,919,209. A delayed cross-linking system may also be used in embodiments of the invention. U.S. Pat. Nos. 5,160,643, 5,372,732, and 6,060,436 disclose various delayed borate cross-linking system that can be used in embodiments of the invention. Additional suitable borate cross-linking agents are disclosed in the following U.S. Pat. No. 4,619,776; No. 5,082,579, No. 5,145,590, No. 5,372,732; No. 5,614,475; No. 5,681,796; No. 6,060,436; and No. 6,177,385.

When desired, it is possible to combine a borate compound with a zirconium compound or titanium compound as cross-linking agents, for example, in a manner disclosed in U.S. Pat. No. 5,165,479. However, when a relatively higher fracture conductivity is desired, cross-linking agents (e.g., zirconium cross-linking agents) which cause reduced fracture conductivity are not used with a borate cross-linking agent. Under these circumstances, only those cross-linking agents which do not adversely affect the fracture conductivity (e.g., borate cross-linking agents) are used in a fracturing fluid.

The pH of an aqueous fluid which contains a hydratable polymer can be adjusted if necessary to render the fluid compatible with a crosslinking agent. Desirable pH ranges for a fluid depend upon the type of a crosslinking agent used. When a borate crosslinking agent is used, suitable pH ranges are greater than about 7, for example from about 8 to about 11. On the other hand, for an antimony crosslinking agent, suitable pH ranges are from about 3 to about 6. Specific examples of pH values include about 3, about 4, about 5, about 6, about 7, about 8, about 9, about 10, about 11, about 12, and ranges between any two of these values.

To obtain a desired pH value, a pH adjusting material preferably is added to the aqueous fluid after the addition of the polymer to the aqueous fluid. Typical materials for adjusting the pH are commonly used acids, acid buffers, and mixtures of acids and bases. For example, hydrochloric acid, fumaric acid, sodium bicarbonate, sodium diacetate, potassium carbonate, sodium hydroxide, potassium hydroxide, and sodium carbonate are typical pH adjusting agents. Acceptable pH values for the fluid may range from acidic, neutral, to basic, i.e., from about 0.5 to about 14. In some embodiments, the pH is kept neutral or basic, i.e., from about 7 to about 14, more preferably about 8 to about 12. In other embodiments, suitable pH ranges include about 9 to about 11, between about 7 to about 11, between about 7 to about 12, about 5 to about 9, about 3 to about 10, or about 6 to about 9. In still other embodiments, a fracturing fluid may have an initial pH of less than about 7.5, such as about 3.5, about 5, or about 5.5. The pH may then be increased to above 7.5, such as about 8.5 to about 11. After the treatment, the pH may be decreased to less than about 7.5. It is also possible to have a pH outside the above ranges. Therefore, a fracturing fluid may be acidic, neutral, or basic, depending on how it is used in well treatments.

The viscosity of the fracturing fluid can generally be any viscosity, and may be selected depending on the particular conditions encountered. The viscosity can be at least about 100 cP at 40 sec⁻¹, at least about 150 cP at 40 sec⁻¹ , at least about 200 cP at 40 sec⁻¹, at least about 250 cP at 40 sec⁻¹, or at least about 300 cP at 40 sec⁻¹, or any range between any of two of these values. Viscosities can be measured using a Fann 50C Rheometer or equivalent using procedures as defined in API RP 13M or ISO-13503-1.

Optionally, the fracturing fluid may further include various other fluid additives, such as pH buffers, biocides, stabilizers, propping agents (i.e., proppants), mutual solvents, and surfactants designed to prevent emulsion with formation fluids, to reduce surface tension, to enhance load recovery, and/or to foam the fracturing fluid. The fracturing fluid may also contain one or more salts, such as potassium chloride, magnesium chloride, sodium chloride, calcium chloride, tetramethyl ammonium chloride, and mixtures thereof. Common clay stabilizers that may be used in the fracturing fluid include potassium chloride, quartenary ammonium salts, etc. Ammonium salts which have four alkyl groups bonded to nitrogen are call quartenary ammonium salts. The four alkyl groups may be the same or different. Preferably, they are C₁-C₈ alkyl groups, e.g., methyl, ethyl, propyl, butyl, pentyl, hexyl, heptyl, and octyl groups. Suitable anions in the salts include chloride, fluoride, iodide, bromide, acetate, etc. An example of an quartenary ammonium salt is tetramethyl ammonium chloride.

The fracturing fluid in accordance with embodiments of the invention may further comprise a breaking agent or a breaker. The term “breaking agent” or “breaker” refers to any chemical that is capable of reducing the viscosity of a gelled fluid. As described above, after a fracturing fluid is formed and pumped into a subterranean formation, it is generally desirable to convert the highly viscous gel to a lower viscosity fluid. This allows the fluid to be easily and effectively removed from the formation and to allow desired material, such as oil or gas, to flow into the well bore. This reduction in viscosity of the treating fluid is commonly referred to as “breaking”. Consequently, the chemicals used to break the viscosity of the fluid is referred to as a breaking agent or a breaker.

There are various methods available for breaking a fracturing fluid or a treating fluid. Typically, fluids break after the passage of time and/or prolonged exposure to high temperatures. However, it is desirable to be able to predict and control the breaking within relatively narrow limits. Mild oxidizing agents are useful as breakers when a fluid is used in a relatively high temperature formation, although formation temperatures of 300° F. (149° C.) or higher will generally break the fluid relatively quickly without the aid of an oxidizing agent.

Both organic oxidizing agents and inorganic oxidizing agents have been used as breaking agents. Any breaking agent or breaker, both inorganic and organic, may be used in embodiments of the invention. Examples of organic breaking agents include organic peroxides, and the like.

Examples of inorganic breaking agents include persulfates, percarbonates, perborates, peroxides, chlorites, hypochlorites, oxides, perphosphates, permanganates, etc. Specific examples of inorganic breaking agents include ammonium persulfates, alkali metal persulfates, alkali metal percarbonates, alkali metal perborates, alkaline earth metal persulfates, alkaline earth metal percarbonates, alkaline earth metal perborates, alkaline earth metal peroxides, alkaline earth metal perphosphates, zinc salts of peroxide, perphosphate, perborate, and percarbonate, alkali metal chlorites, alkali metal hypochlorites, KBrO₃, KClO₃, KIO₃, sodium persulfate, potassium persulfate, and so on. Additional suitable breaking agents are disclosed in U.S. Pat. No. 5,877,127; No. 5,649,596; No. 5,669,447; No. 5,624,886; No. 5,106,518; No. 6,162,766; and No. 5,807,812.

In addition, enzymatic breakers may also be used in place of or in addition to a non-enzymatic breaker. Examples of suitable enzymatic breakers are disclosed, for example, in U.S. Pat. No. 5,806,597 and No. 5,067,566. A breaking agent or breaker may be used as is or be encapsulated and activated by a variety of mechanisms including crushing by formation closure or dissolution by formation fluids. Such techniques are disclosed, for example, in U.S. Pat. No. 4,506,734; No. 4,741,401; No. 5,110,486; and No. 3,163,219. In some embodiments, an inorganic breaking agent is selected from alkaline earth metal or transition metal-based oxidizing agents, such as magnesium peroxides, zinc peroxides, and calcium peroxides. Other suitable breakers include the ester compounds disclosed in U.S. Patent Publication No. US 2002-0125012 A1, published Sep. 12, 2002.

As described above, propping agents or proppants may be added to the fracturing fluid, which is typically done prior to the addition of a crosslinking agent. However, proppants may be introduced in any manner which achieves the desired result. Any proppant may be used in embodiments of the invention. Examples of suitable proppants include quartz sand grains, glass and ceramic beads, walnut shell fragments, aluminum pellets, nylon pellets, and the like. Proppants are typically used in concentrations between about 1 to 8 pounds per gallon (about 0.1 to about 1 kg/l) of a fracturing fluid, although higher or lower concentrations may also be used as desired. The fracturing fluid may also contain other additives, such as surfactants, corrosion inhibitors, mutual solvents, stabilizers, paraffin inhibitors, tracers to monitor fluid flow back, etc.

Methods of Use

The fracturing fluids described above in accordance with various embodiments of the invention have many useful applications. For example, it may be used in hydraulic fracturing, gravel packing operations, water blocking, temporary plugs for purposes of wellbore isolation and/or fluid loss control, and other well completion operations. One application of the fracturing fluid is in hydraulic fracturing processes.

Accordingly, an additional embodiment of the invention is directed towards methods for treating a subterranean formation. The methods can comprise: obtaining a fracturing fluid comprising a liquid, a polymer soluble in the liquid, having a multi-modal molecular weight distribution, and a crosslinking agent capable of increasing the viscosity of the fracturing fluid by crosslinking the polymer in liquid; and injecting the fracturing fluid into a bore hole to contact at least a portion of the subterranean formation. The “obtaining” step can involve obtaining the fracturing fluid pre-mixed from a third party, or can involve mixing the various components prior to the injection step. The fracturing fluid can generally be any of the fracturing fluids discussed above.

It should be understood that the above-described method is only one way to carry out embodiments of the invention. The following U.S. Patents disclose various techniques for conducting hydraulic fracturing which may be employed in embodiments of the invention with or without modifications: U.S. Pat. Nos. 6,169,058; 6,135,205; 6,123,394; 6,016,871; 5,755,286; 5,722,490; 5,711,396; 5,551,516; 5,497,831; 5,488,083; 5,482,116; 5,472,049; 5,411,091; 5,402,846; 5,392,195; 5,363,919; 5,228,510; 5,074,359; 5,024,276; 5,005,645; 4,938,286; 4,926,940; 4,892,147; 4,869,322; 4,852,650; 4,848,468; 4,846,277; 4,830,106; 4,817,717; 4,779,680; 4,479,041; 4,739,834; 4,724,905; 4,718,490; 4,714,115; 4,705,113; 4,660,643; 4,657,081; 4,623,021; 4,549,608; 4,541,935; 4,378,845; 4,067,389; 4,007,792; 3,965,982; and 3,933,205.

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the scope of the invention.

### EXAMPLES

### Example 1

### Linear Gel Viscosity and Shear Rate of Low and High Molecular Weight Polymers Evaluated Separately

The viscosity (in cps) of various guar polymer compositions was determined against various shear rates (in sec⁻¹) at 70° F. (21° C.) using a Fann Model 35 Viscometer, available from Fann Instruments. Two guar polymer compositions were used: a low molecular weight guar (weight average molecular weight of approximately 350,000 Daltons), and a high molecular weight guar (weight average molecular weight of approximately 2,000,000 Daltons).

Five different loadings of low molecular weight guar were prepared in water (10 ppt, 20 ppt, 60 ppt, 80 ppt, and 100 ppt). One loading of high molecular weight guar was prepared in water (20 ppt).

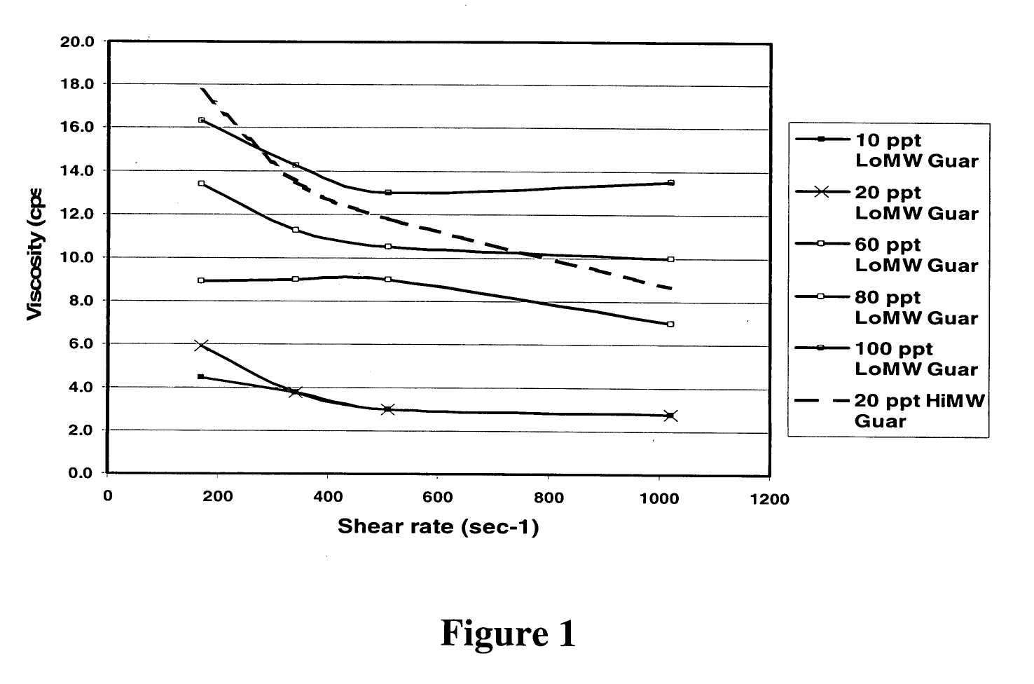

The viscosities were determined at shear rates of 40 sec⁻¹, 100 sec⁻¹, and 170 sec⁻¹. The results are shown in FIG. 1. About 3.5 to 5.5 times the loading of low molecular weight guar is required to provide the same linear gel viscosity as that obtained with the high molecular weight guar. The values are somewhat dependent on the actual molecular weight of the polymers. For example a higher loading of a lower molecular weight polymer may be required to generate the same linear gel viscosity.

### Example 2

### Viscosity of Combined Polymer Compositions

Aqueous compositions were prepared containing low molecular weight guar, high molecular weight guar, or combinations thereof. Viscosities in cps were determined at 511 sec⁻¹ and 70° F. (21° C.). Polymer loadings of 10, 20, 30, 40, 50, 60, and 80 lb/Mgal were prepared for each of the two polymers separately. Combined polymer compositions were prepared using four different formulations: (1) 10 lb/Mgal low molecular weight guar+X lb/Mgal high molecular weight guar (where 10+X=the polymer loading), (2) 20 lb/Mgal low molecular weight guar+X lb/Mgal high molecular weight guar (where 20+X=the polymer loading), (3) 30 lb/Mgal low molecular weight guar+X lb/Mgal high molecular weight guar (where 30+X=the polymer loading), and (4) 40 lb/Mgal low molecular weight guar+X lb/Mgal high molecular weight guar (where 40+X=the polymer loading).

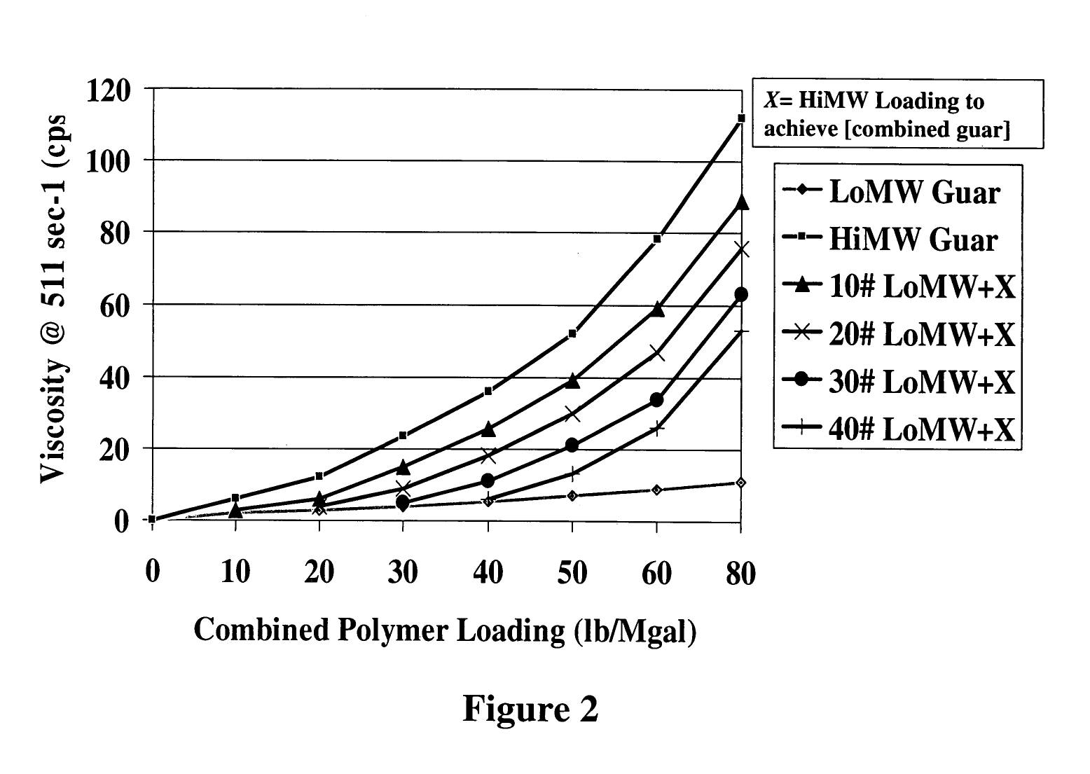

The viscosities vs. polymer loading is shown in FIG. 2. Linear gel viscosities of the mixed polymer systems were between the viscosities observed from compositions containing the two polymers individually.

### Example 3

### Comparison of Normalized Linear Gel Viscosities of Mono-Modal and Bi-Modal Polymer Mixtures

Four aqueous polymer compositions containing 25, 30, 35, and 40 lb/Mgal high molecular weight guar were prepared. Three polymer mixtures containing 30/10, 25/15, and 20/20 lb/Mgal high molecular weigh guar /low molecular weight guar were also prepared.

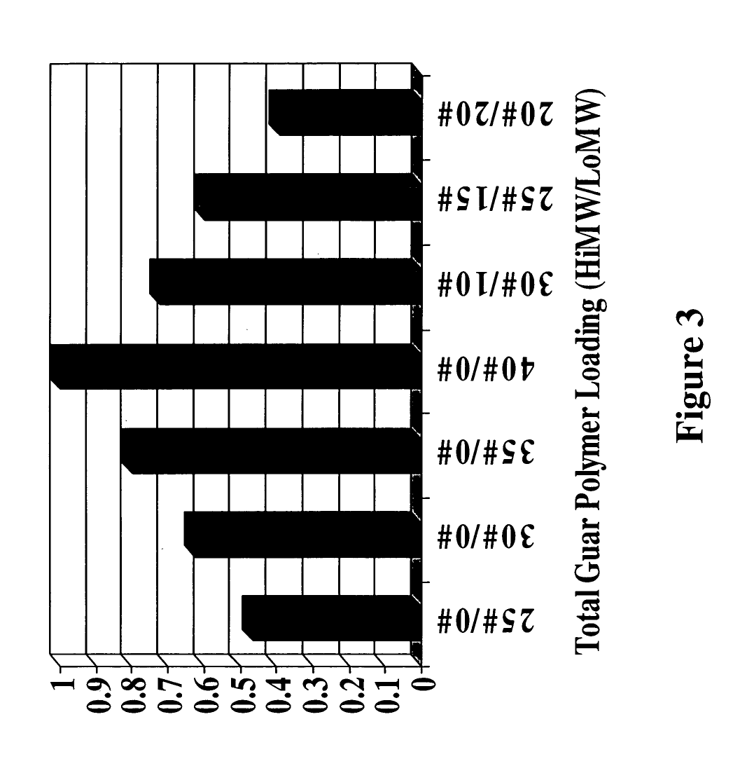

The four mono-modal compositions (containing only high molecular weight guar) and the three bi-modal compositions (containing both the high molecular weight guar and the low molecular weight guar) were assayed for their linear gel viscosity at 511 sec⁻¹ and 70° F. (21° C.). The values were normalized, with the viscosity of the 40 lb/Mgal high molecular weight guar being assigned a value of 1. The results are shown in FIG. 3.

### Example 4

### Vortex Closure Time Assays for Mono-Modal and Bi-Modal Polymer Mixtures

Vortex closure time values of polymer compositions were determined using a Waring blender equipped with a rheostat at 70° F. (21° C.). Testing was conducted using 1.25 gal/Mgal XLW-24 (an organoborate crosslinker offered by BJ Services Company, described in U.S. Pat. No. 5,082,579 and U.S. Pat. No. 5,160,643, both assigned to BJ Services Company and incorporated by reference herein) and 3 gal/Mgal 40% solution of potassium carbonate (available as BF-7L from BJ Services Company). The initial crosslinked pH was 10.0+/−0.1. The following seven compositions were prepared and assayed, with all having combined polymer concentrations of 40 lb/Mgal.

| | High MW guar | Low MW guar | Combined polymer |
|---|---|---|---|
| Sample | (lb/Mgal) | (lb/Mgal) | (lb/Mgal) |
| 1 | 40 | 0 | 40 |
| 2 | 30 | 10 | 40 |
| 3 | 25 | 15 | 40 |
| 4 | 20 | 20 | 40 |
| 5 | 15 | 25 | 40 |
| 6 | 10 | 30 | 40 |
| 7 | 0 | 40 | 40 |

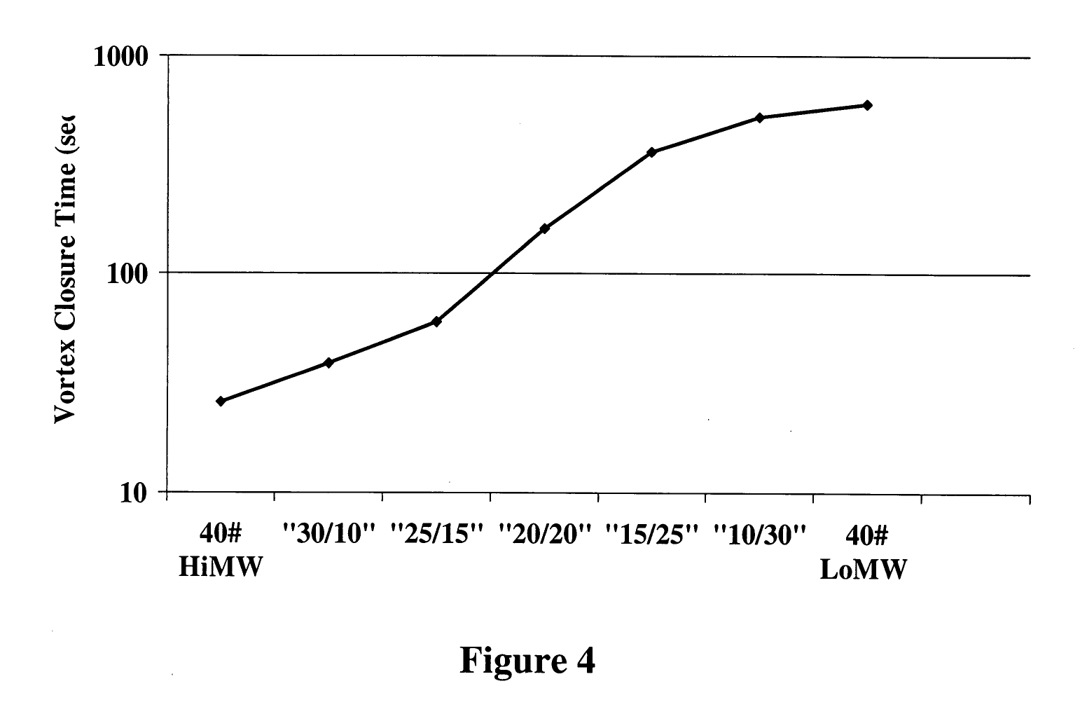

The vortex closure times in seconds are shown in FIG. 4. Mixtures containing greater concentrations of high molecular weight guar have faster closure times.

The vortex closure is a measure of the time to develop a crosslinked gel. It is desirable to minimize the friction pressure of the fluid while it is traveling down the tubing until near the time that it reached the perforations to enter the fracture. In the tubing, until just above the perforations (in a vertical well) there is little concern for carrying the proppant as the fluid is moving at a high rate (most typically in turbulence). The transit time for the surface blender to the perforations is typically on the order of 2 to 10 minutes, depending on the pump rate, tubular size, and reservoir depth.

At the perforations, upon entering the fracture, proppant carrying capability is highly desirable. The flow converts to laminar very soon after exiting the perforations into the fracture. It is by this point that it is preferable to have the fluid crosslinked in order to have the requisite viscosity to carry the proppant. Delayed crosslinking is desirable, but control of the time at which the fluid crosslinks is also desirable. With a given polymer loading (with a monomodal MW) and conditions (shear, temperature, etc) this control is usually achieved by either solubility in the case of the borate ores, or, chelating the crosslinker and employing a pH profile to adjust the time.

It was observed that the crosslink time could be lengthened by increasing the ratio of the smaller MW component in a bi-modal polymer mixture. For example, a 40 pound system with 20 pound high MW guar and 20 pound low MW guar crosslinks much slower than at system with 40 pound high MW guar alone. However, the ultimate viscosities achieved upon crosslinking of both systems is similar.

In the case of blocking gels, it is desired to have relatively very long crosslink times in order to allow placement of the uncrosslinked fluid in the target zone prior to onset of crosslinking.

The controlled long time delay of crosslinking can be very valuable in the case of small tubulars such as coiled tubing as the friction problem of crosslinking in the tubing can be acute, if not impossible to overcome.

### Example 5

### Vortex Closure Time Assays for Mono-Modal and Bi-Modal Polymer Mixtures

A similar set of experiments were performed with the following set of six mixtures, with all having combined polymer concentrations of 50 lb/Mgal. Testing was conducted using 4.5 gal/Mgal XLW-24, 7 gal/Mgal BF-7L, and 10 lb/Mgal of sodium bicarbonate (available as BF-3 from BJ Services Company). The initial crosslinked pH was 10.0+/−0.1

| | High MW guar | Low MW guar | Combined polymer |
|---|---|---|---|
| Sample | (lb/Mgal) | (lb/Mgal) | (lb/Mgal) |
| 1 | 50 | 0 | 50 |
| 2 | 40 | 10 | 50 |
| 3 | 30 | 20 | 50 |
| 4 | 20 | 30 | 50 |
| 5 | 10 | 40 | 50 |
| 6 | 0 | 50 | 50 |

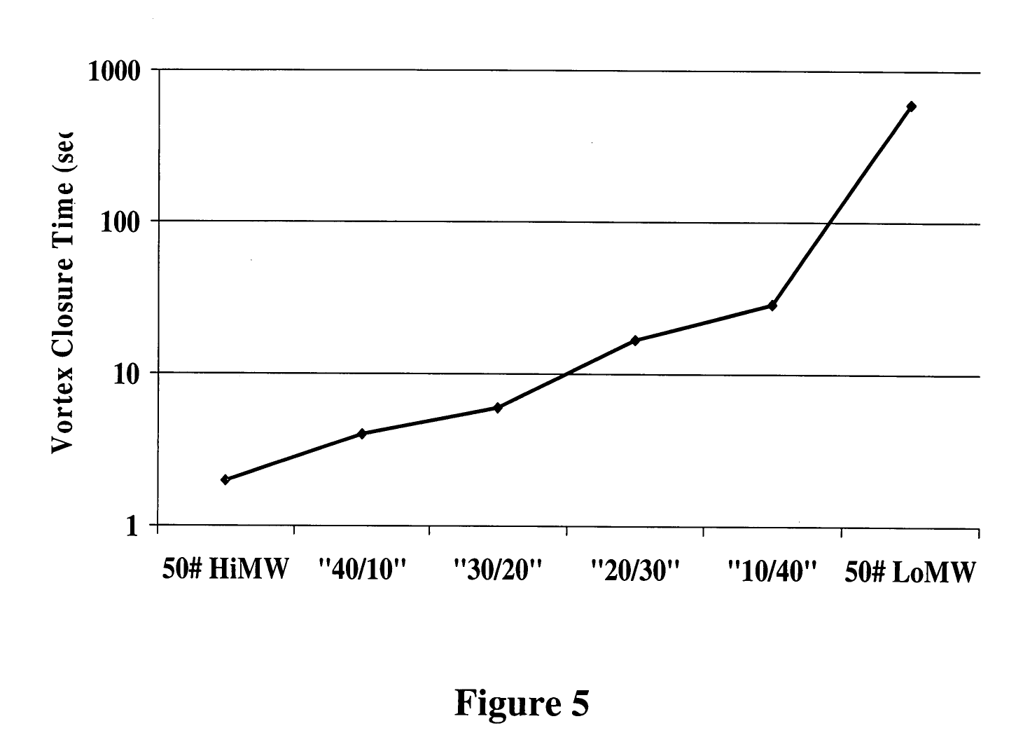

The vortex closure times in seconds are shown in FIG. 5. As before, mixtures containing greater concentrations of high molecular weight guar have faster closure times.

Higher combined concentrations inherently crosslink more rapidly. These data illustrate that although the crosslink times for a higher combined concentration of a given ratio of high MW: low MW mixture are faster the for lower combined concentrations, that higher ratios of the lower MW guar in bimodal blends are much slower. For example, a 50 pound 50:50 blend crosslinks more quickly than a 40 pound 50:50 bimodal blend, but much more slowly than a 50 pound 100% high MW guar.

### Example 6

### Vortex Closure Time Assays for Mono-Modal and Bi-Modal Polymer Mixtures

A similar set of experiments were performed with the following set of three mixtures, with all having combined polymer concentrations of 60 lb/Mgal. Testing was conducted using 1.25 gal/Mgal XLW-24 and 3 gal/Mgal BF-7L. The initial crosslinked pH was 10.0+/−0.1

| | High MW guar | Low MW guar | Combined polymer |
|---|---|---|---|
| Sample | (lb/Mgal) | (lb/Mgal) | (lb/Mgal) |
| 1 | 60 | 0 | 60 |
| 2 | 30 | 30 | 60 |
| 3 | 0 | 60 | 60 |

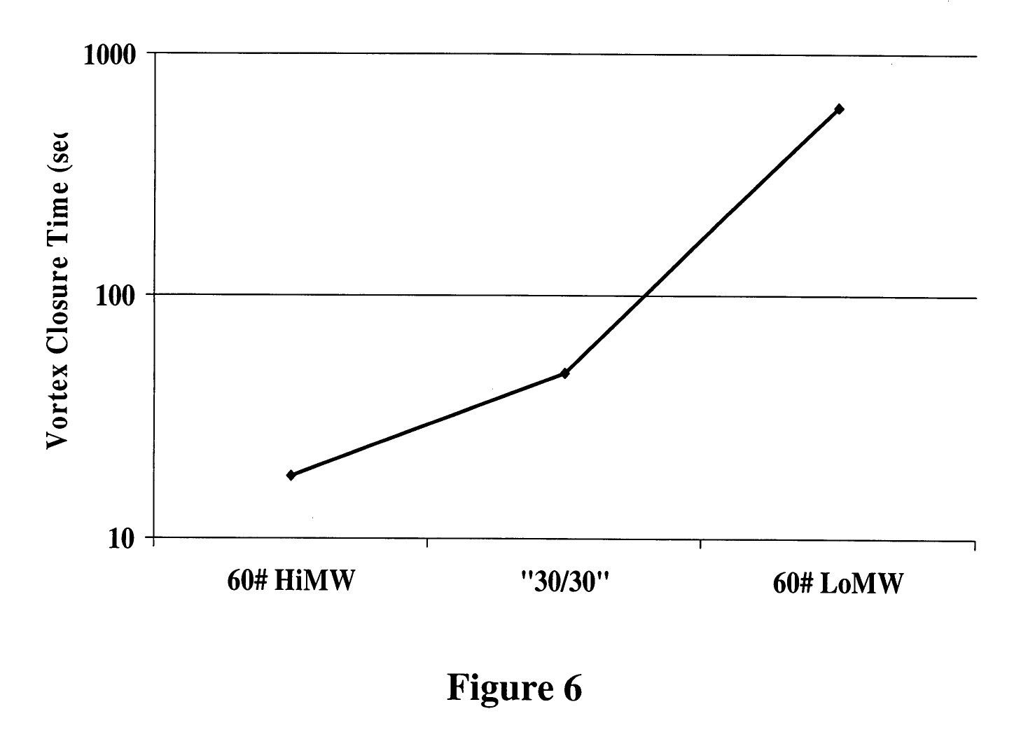

The vortex closure times in seconds are shown in FIG. 6. As before, mixtures containing greater concentrations of high molecular weight guar have faster closure times. These results are consistent with those obtained in the previous Example.

### Example 7

### Determination of Dynamic Moduli for Mono-Modal and Bi-Modal Polymer Mixtures

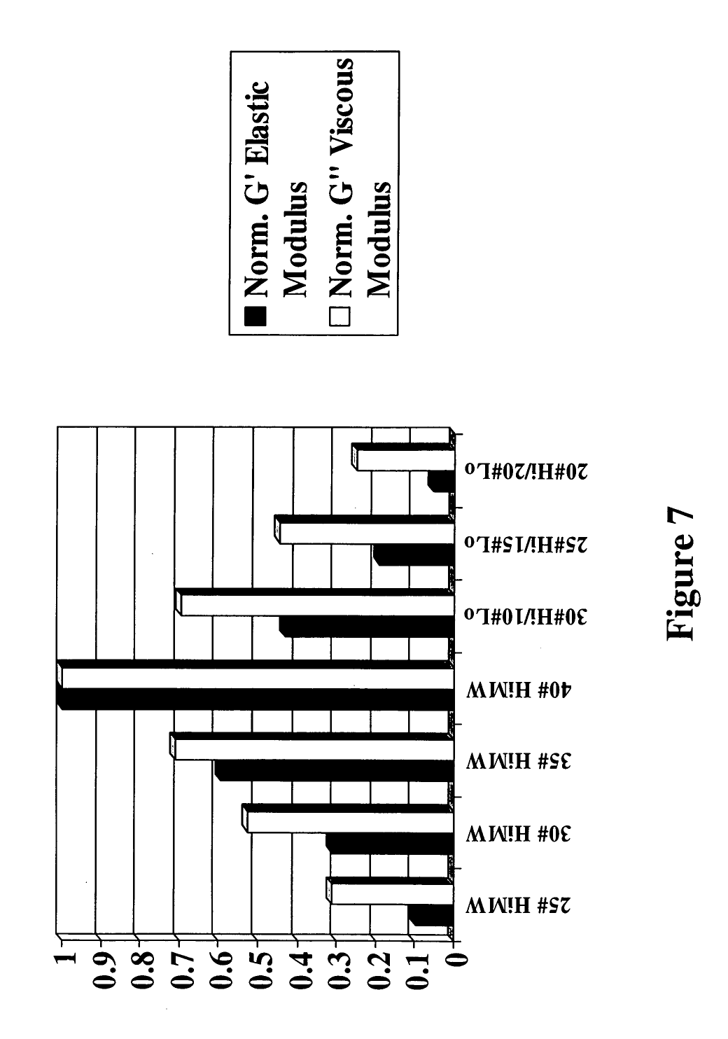

Testing was conducted using a 40 lb/Mgal polymer system with 2.0 gal/Mgal XLW-24 and 5.0 gal/Mgal BF-7L. The initial crosslinked pH was 10.0+/−0.1 Elastic modulus and viscous modulus values were determined for mono-modal and bi-modal polymer mixtures at 70° F. (21° C.) using a Haake RS-1 Rheometer (Thermo Electron Corporation; Waltham, Mass.). The Rheometer was fitted with a cone and plate fixture having a cone angle of four degrees, and a diameter of 35 mm. All sweeps were performed at room temperature using constant deformation at a shear strain of 0.05, which is in the linear viscoelastic range. The values were normalized, with the modulus of the 40 lb/Mgal high molecular weight guar composition being assigned a value of 1, (see FIG. 7). The bimodal 25 lb/Mgal high molecular weight+15 lb/Mgal low molecular weight mixture provides elastic modulus and viscous modulus values about equal to 27.8 lb/Mgal and 26.9 lb/Mgal monomodal high molecular weight compositions.

### Example 8

### Comparison of Vortex Closure Time vs. Combined Polymer Loading

Vortex closure time values of polymer compositions were determined using a Waring blender at 70° F. (21° C.) as described in an earlier Example. Testing was conducted on 20-40 lb/Mgal polymer systems using 1.25 gal/Mgal XLW-24 and 3 gal/Mgal BF-7L. The initial crosslinked pH was 10.0+/−0.1 The following ten compositions were prepared and assayed.

| | High MW guar | Low MW guar | Combined polymer |
|---|---|---|---|
| Sample | (lb/Mgal) | (lb/Mgal) | (lb/Mgal) |
| 1 | 40 | 0 | 40 |
| 2 | 30 | 10 | 40 |
| 3 | 30 | 0 | 30 |
| 4 | 25 | 15 | 40 |
| 5 | 25 | 0 | 25 |
| 6 | 20 | 20 | 40 |
| 7 | 20 | 0 | 20 |
| 8 | 15 | 25 | 40 |
| 9 | 10 | 30 | 40 |
| 10 | 0 | 40 | 40 |

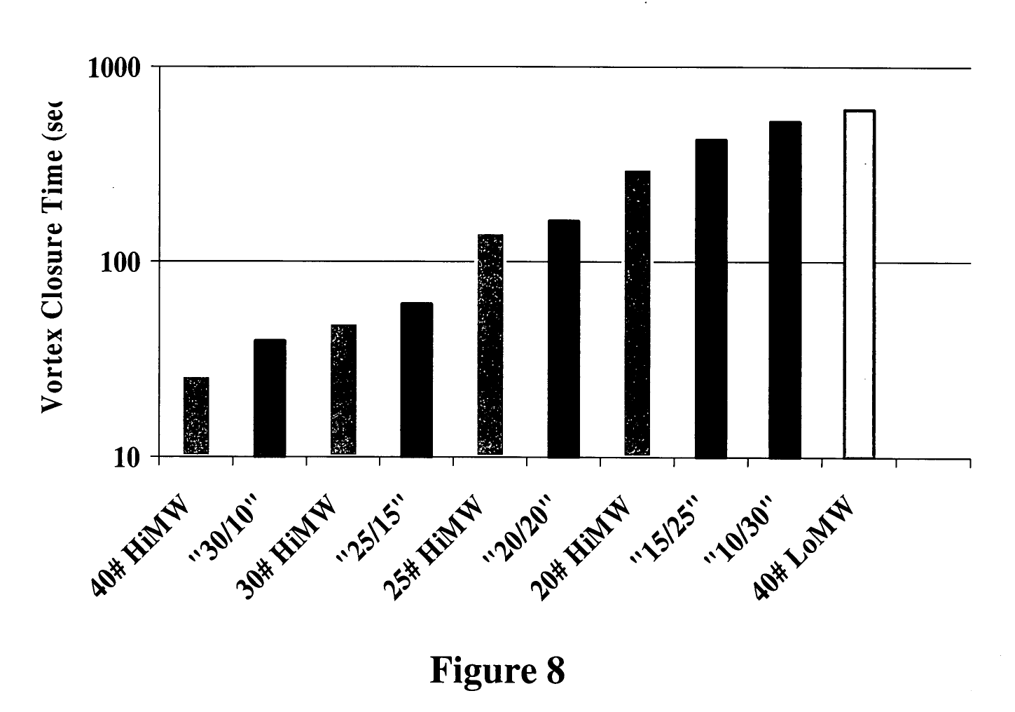

The results are shown in FIG. 8. Exponentially longer crosslink delay times are observed with higher percentages of the bimodal polymer mixture being made of the low molecular weight guar polymer.

### Example 9

### Viscosity of Monomodal and Bimodal Polymer Mixtures after Exposure to High Temperatures for 20 Minutes

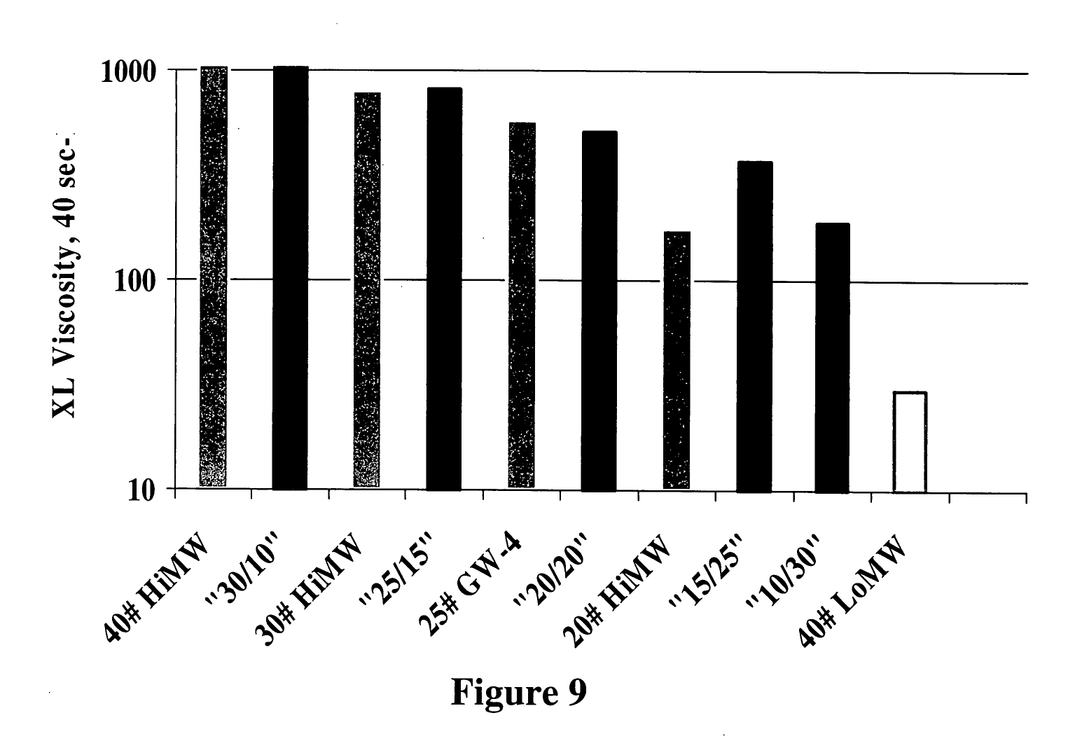

The viscosity of the ten mixtures from the previous example were determined after being heated at 160° F. (71° C.) for 20 minutes. The results are shown in FIG. 9. The mixture of 25 lb/Mgal high molecular weight polymer and 15 lb/Mgal low molecular weight polymer provided a similar crosslinked viscosity as did the 30 lb/Mgal high molecular weight mono-modal polymer. As in Example 8, testing was conducted on 20-40 lb/Mgal polymer systems using 1.25 gal/Mgal XLW-24 and 3 gal/Mgal BF-7. The initial crosslinked pH was 10.0+/−0.1

### Example 10

### Viscosity of Monomodal and Bimodal Polymer Mixtures after Exposure to High Temperatures for 60 Minutes

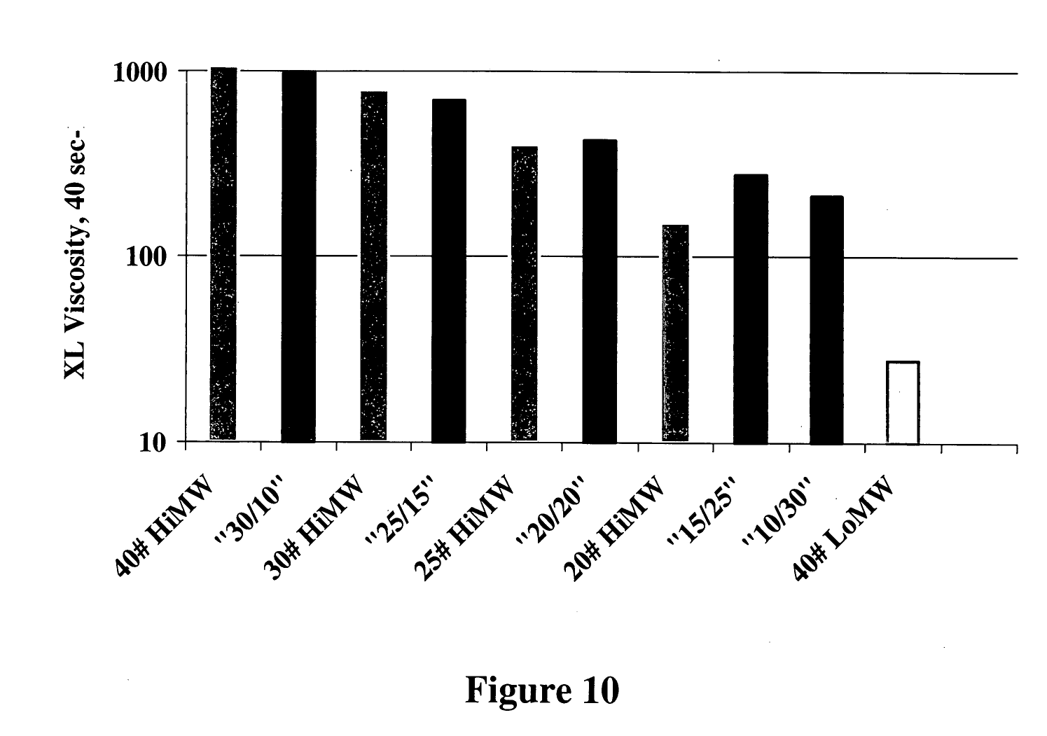

The viscosity of the ten mixtures from the previous example were determined after being heated at 160° F. (71° C.) for 60 minutes. The results are shown in FIG. 10. The mixture of 30 lb/Mgal high molecular weight polymer and 10 lb/Mgal low molecular weight polymer provided a similar crosslinked viscosity as did the 40 lb/Mgal high molecular weight mono-modal polymer. As in Example 8, testing was conducted on 20-40 lb/Mgal polymer systems using 1.25 gal/Mgal XLW-24 and 3 gal/Mgal BJ-7. The initial crosslinked pH was 10.0+/−0.1

### Example 11

### Viscosity of Monomodal and Bimodal Polymer Mixtures after Exposure to High Temperatures for 20 Minutes

The viscosity of the following seven mixtures were determined after being heated at 160° F. (71° C.) for 20 minutes.

| | High MW guar | Low MW guar | Combined polymer |
|---|---|---|---|
| Sample | (lb/Mgal) | (lb/Mgal) | (lb/Mgal) |
| 1 | 50 | 0 | 50 |
| 2 | 40 | 10 | 50 |
| 3 | 30 | 20 | 50 |
| 4 | 20 | 30 | 50 |
| 5 | 10 | 40 | 50 |
| 6 | 0 | 50 | 50 |
| 7 | 40 | 0 | 40 |

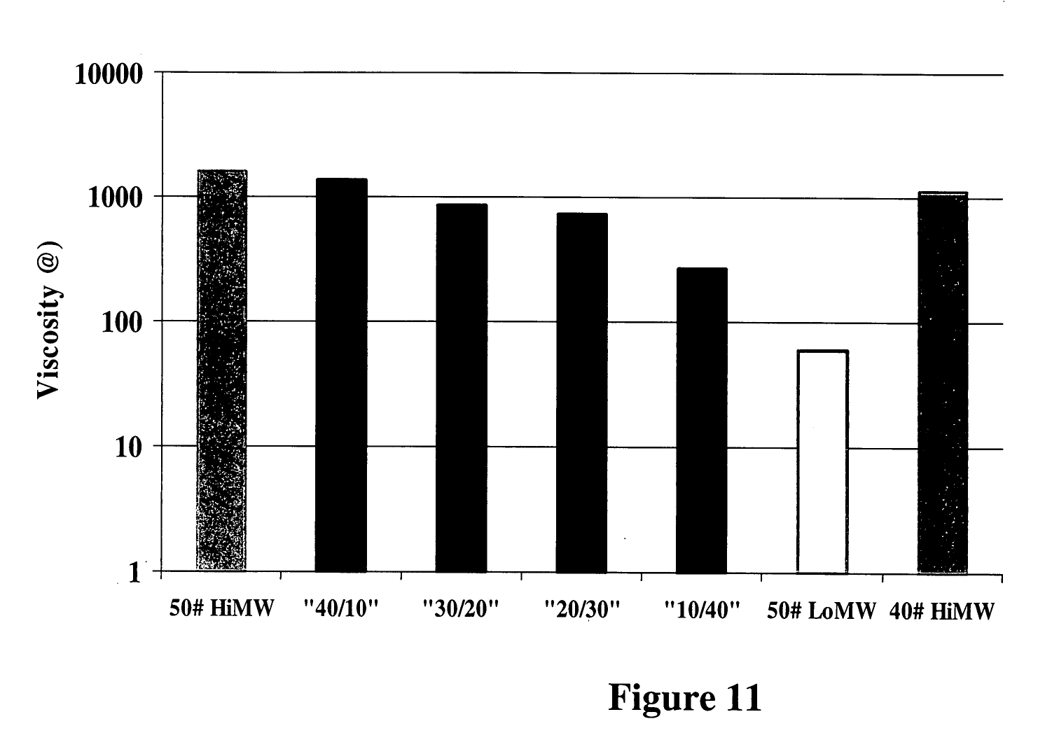

The results are shown in FIG. 11. The bimodal mixture of 40 lb/Mgal high molecular weight polymer and 10 lb/Mgal low molecular weight polymer provided a similar crosslinked viscosity as did the 50 lb/Mgal high molecular weight mono-modal polymer. All 50 lb/Mgal polymer systems used 4.5 gal/Mgal XLW-24 and 7 gal/Mgal of BF-7L. The 40 lb/Mgal polymer system used 1.25 gal/Mgal XLW-24 and 3.0 gal/Mgal of BF-7L. The initial crosslinked pH was 10.0+/−0.1

### Example 12

### Viscosity of Monomodal and Bimodal Polymer Mixtures after Exposure to High Temperatures for 60 Minutes

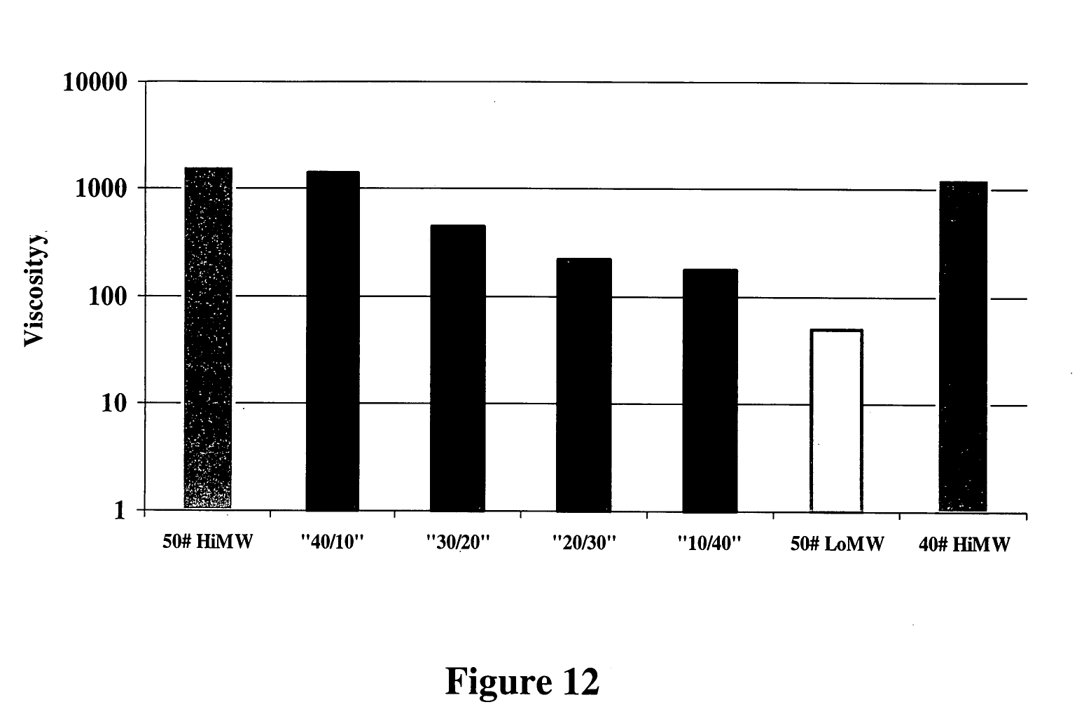

The viscosity of the seven mixtures from the previous example were determined after being heated at 160° F. (71° C.) for 60 minutes. The results are shown in FIG. 12. The mixture of 40 lb/Mgal high molecular weight polymer and 10 lb/Mgal low molecular weight polymer provided a similar crosslinked viscosity as did the 50 lb/Mgal high molecular weight mono-modal polymer.

### Example 13

### Rheology of Monomodal and Bimodal Polymer Mixtures at High Temperature

The viscosity of the following five compositions was measured as a function of time, with the compositions being held at 160° F. (71° C.). Testing was conducted on 20 to 40 lb/Mgal polymer systems using 1.25 gal/Mgal XLW-24 and 3.0 gal/Mgal of BF-7L. The initial crosslinked pH was 10.0+/−0.1

| | High MW guar | Low MW guar | Combined polymer |
|---|---|---|---|
| Sample | (lb/Mgal) | (lb/Mgal) | (lb/Mgal) |
| 1 | 40 | 0 | 40 |
| 2 | 30 | 0 | 30 |
| 3 | 25 | 0 | 25 |
| 4 | 20 | 0 | 20 |
| 5 | 20 | 10 | 30 |

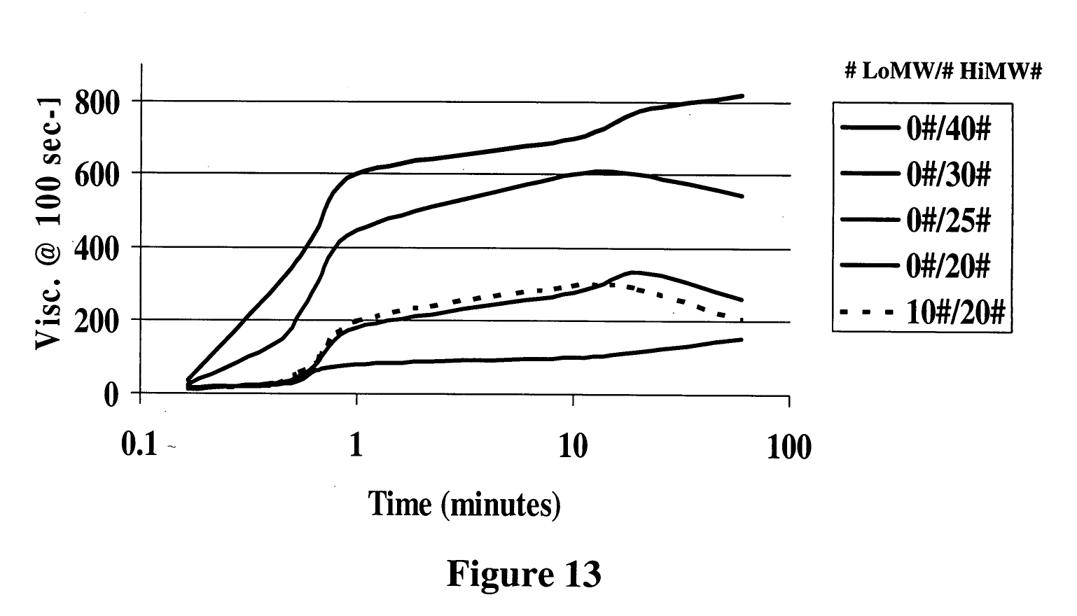

The results are shown in FIG. 13. The bimodal composition displayed a rheological behavior similar to that observed in the monomodal 25 lb/Mgal high molecular weight polymer.

### Example 14

### Rheology of Monomodal and Bimodal Polymer Mixtures at High Temperature

The viscosity of the following five compositions was measured as a function of time, with the compositions being held at 160° F. (71° C.). Each sample had a combined guar polymer loading of 40 lb/Mgal and was crosslinked with a borate crosslinking agent. The fluid compositions included 1.25 gal/Mgal XLW-24 and 3.0 gal/Mgal of BF-7L. The initial crosslinked pH was 10.0+/−0.1

| | High MW guar | Low MW guar | Combined polymer |
|---|---|---|---|
| Sample | (lb/Mgal) | (lb/Mgal) | (lb/Mgal) |
| 1 | 15 | 25 | 40 |
| 2 | 20 | 20 | 40 |
| 3 | 25 | 15 | 40 |
| 4 | 30 | 10 | 40 |
| 5 | 40 | 0 | 40 |

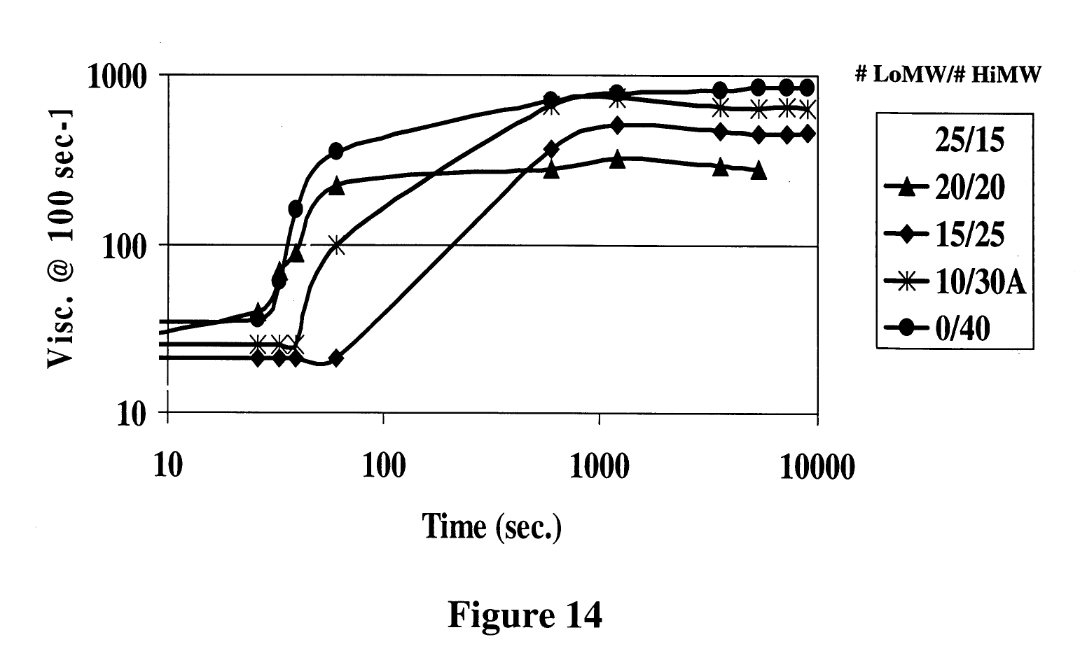

The results are shown in FIG. 14. The bimodal compositions having higher percentage of low molecular weight polymer crosslinked more slowly than did monomodal high molecular weight compositions, but exhibited peak crosslinked viscosities attractive for fracturing applications.

### Example 15

### Rheology of Monomodal and Bimodal Polymer Mixtures at High Temperature

The viscosity of the following nine compositions was measured as a function of time, with the compositions being held at 160° F. (71° C.). Each sample had a combined guar polymer loading of 20 to 40 lb/Mgal and was crosslinked with a borate crosslinking agent. The fluid compositions included 1.25 gal/Mgal XLW-24 and 3.0 gal/Mgal of BF-7L. The initial crosslinked pH was 10.0+/−0.1

| | High MW guar | Low MW guar | Combined polymer |
|---|---|---|---|
| Sample | (lb/Mgal) | (lb/Mgal) | (lb/Mgal) |
| 1 | 40 | 0 | 40 |
| 2 | 30 | 0 | 30 |
| 3 | 25 | 0 | 25 |
| 4 | 20 | 0 | 20 |
| 5 | 30 | 10 | 40 |
| 6 | 25 | 15 | 40 |
| 7 | 20 | 20 | 40 |
| 8 | 15 | 25 | 40 |
| 9 | 10 | 30 | 40 |

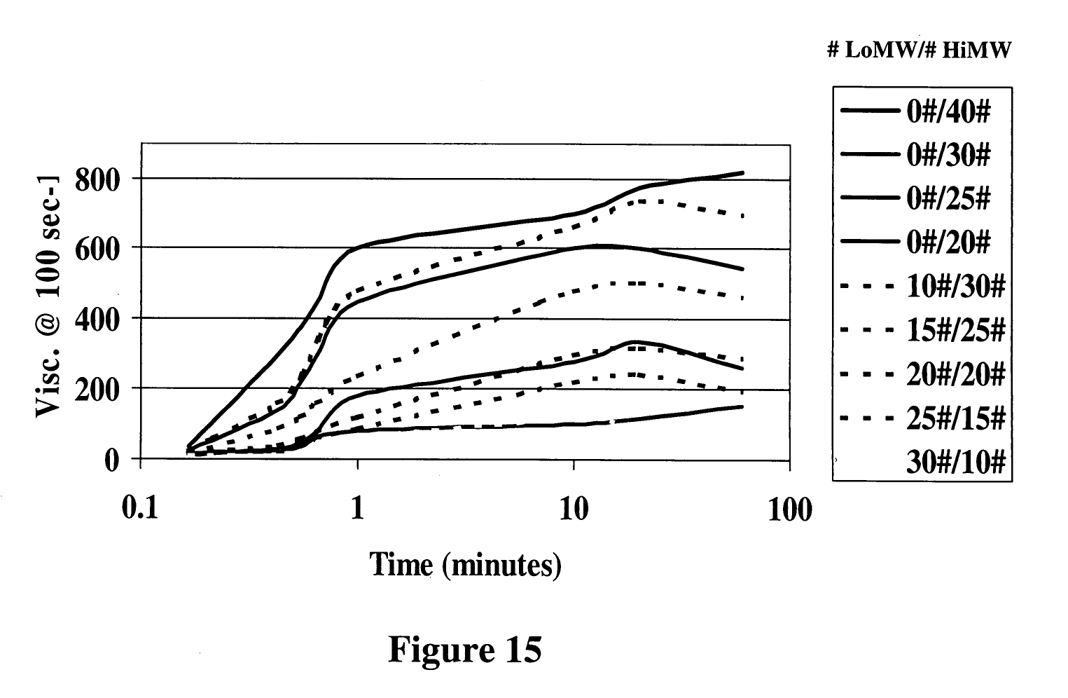

The results are shown in FIG. 15. The bimodal compositions having higher percentages of low molecular weight polymer crosslinked more slowly than did monomodal high molecular weight compositions, but exhibited peak crosslinked viscosities attractive for fracturing applications.

### Example 16

### Rheology of Monomodal and Bimodal Polymer Mixtures at High Temperature

The viscosity of the following seven compositions was measured as a function of time, with the compositions being held at 160° F. (71° C.). Each sample had a combined guar polymer loading of 30 to 50 lb/Mgal and was crosslinked with a borate crosslinking agent. The 50 lb/Mgal polymer system used 4.5 gal/Mgal XLW-24 and 7.0 gal/Mgal of BF-7L. The 40 lb/Mgal and 30 lb/Mgal polymer systems included 1.25 gal/Mgal XLW-24 and 3.0 gal/Mgal of BF-7L. The initial crosslinked pH was 10.0+/−0.1

| | High MW guar | Low MW guar | Combined polymer |
|---|---|---|---|
| Sample | (lb/Mgal) | (lb/Mgal) | (lb/Mgal) |
| 1 | 50 | 0 | 50 |
| 2 | 40 | 0 | 40 |
| 3 | 30 | 0 | 30 |
| 4 | 40 | 10 | 50 |
| 5 | 30 | 20 | 50 |
| 6 | 20 | 30 | 50 |
| 7 | 10 | 40 | 50 |

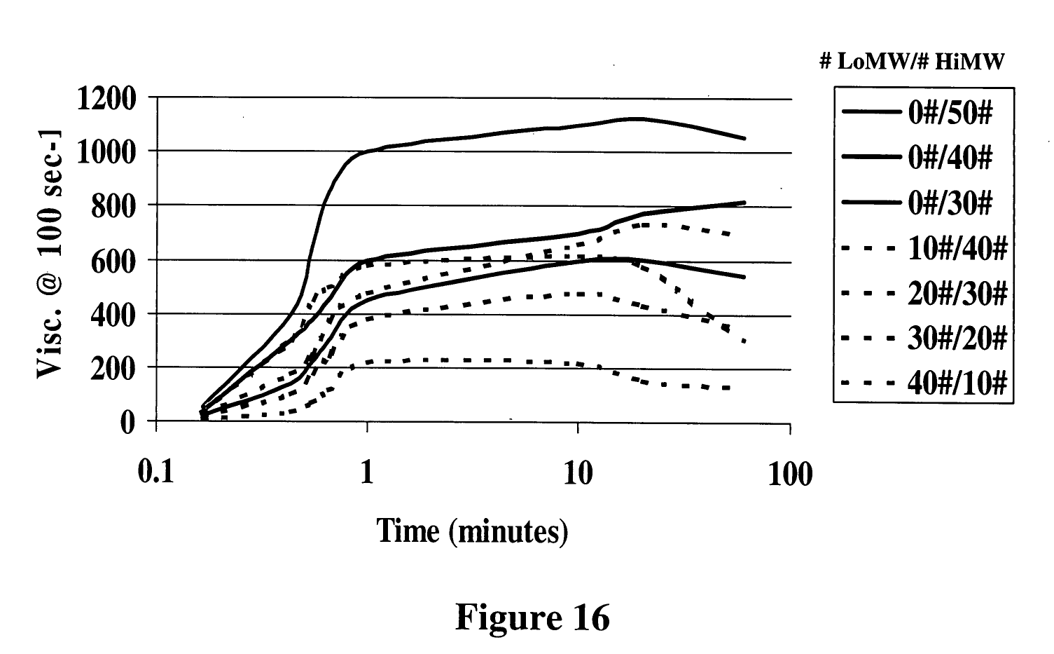

The results are shown in FIG. 16. The bimodal compositions having higher percentages of low molecular weight polymer crosslinked more slowly than did monomodal high molecular weight compositions, but exhibited peak crosslinked viscosities attractive for fracturing applications.

### Example 17

### Rheology of Monomodal and Bimodal Polymer Mixtures at High Temperature

The viscosity of the following four compositions was measured as a function of time, with the compositions being held at 160° F. (71° C.). Each sample had a combined guar polymer loading of 40 to 60 lb/Mgal and was crosslinked with a borate crosslinking agent. The 40 and 60 lb. polymer systems included 1.25 gal/Mgal XLW-24 and 3.0 gal/Mgal BF-7L. The 50 lb/Mgal system included 4.5 gal/Mgal XLW-24 and 7.0 gal/Mgal BF-7L. The initial crosslinked pH was 10.0+/−0.1

| | High MW guar | Low MW guar | Combined polymer |
|---|---|---|---|
| Sample | (lb/Mgal) | (lb/Mgal) | (lb/Mgal) |
| 1 | 60 | 0 | 60 |
| 2 | 50 | 0 | 50 |
| 3 | 40 | 0 | 40 |
| 4 | 30 | 30 | 60 |

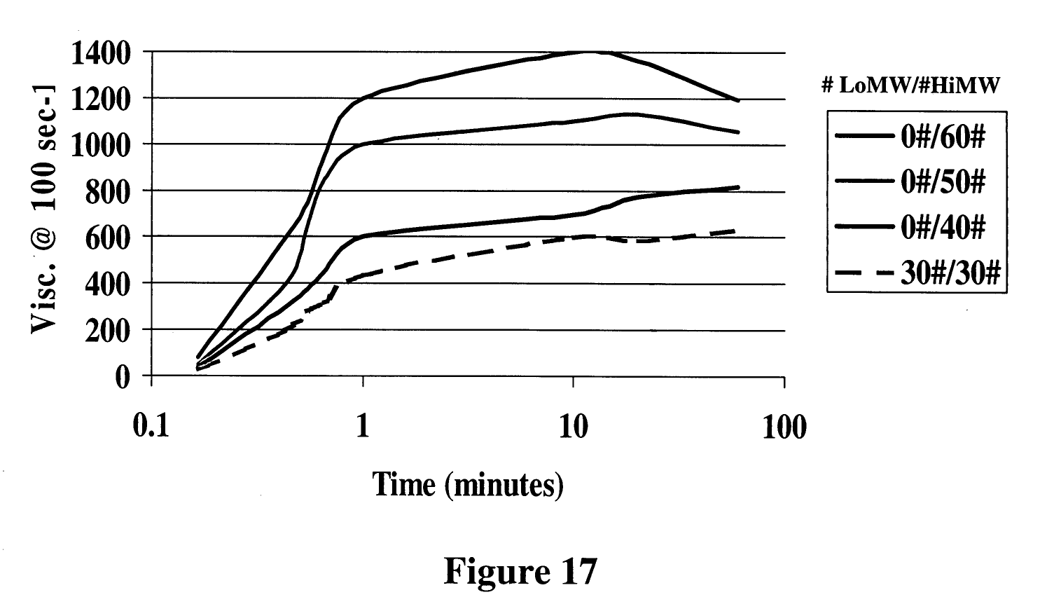

The results are shown in FIG. 17. The bimodal compositions having higher percentages of low molecular weight polymer crosslinked more slowly than did monomodal high molecular weight compositions, but exhibited peak crosslinked viscosities attractive for fracturing applications.

### Example 18

### Rheology of Monomodal and Bimodal Polymer Mixtures at High Temperature

The viscosity of the following six compositions was measured as a function of time, with the compositions being held at 160° F. (71° C.). Each sample had a combined guar polymer loading of 40 to 80 lb/Mgal and was crosslinked with a borate crosslinking agent. The 40, 60 and 80 lb/Mgal polymer systems used loadings of 1.25 gal/Mgal XLW-24 and 3.0 gal/Mgal BF-7L. The 50 lb/Mgal system used loadings of 4.5 gal/Mgal XLW-24 and 7.0 gal/Mgal BF-7L. The initial crosslinked pH was 10.0+/−0.1

| | High MW guar | Low MW guar | Combined polymer |
|---|---|---|---|
| Sample | (lb/Mgal) | (lb/Mgal) | (lb/Mgal) |
| 1 | 80 | 0 | 80 |
| 2 | 60 | 0 | 60 |
| 3 | 50 | 0 | 50 |
| 4 | 40 | 0 | 40 |
| 5 | 40 | 40 | 80 |
| 6 | 0 | 80 | 80 |

The results are shown in FIG. 18. The bimodal compositions having higher percentages of low molecular weight polymer crosslinked more slowly than did monomodal high molecular weight compositions, but exhibited peak crosslinked viscosities attractive for fracturing applications.

### Example 19

### Typical Behavior of Fracturing Fluids

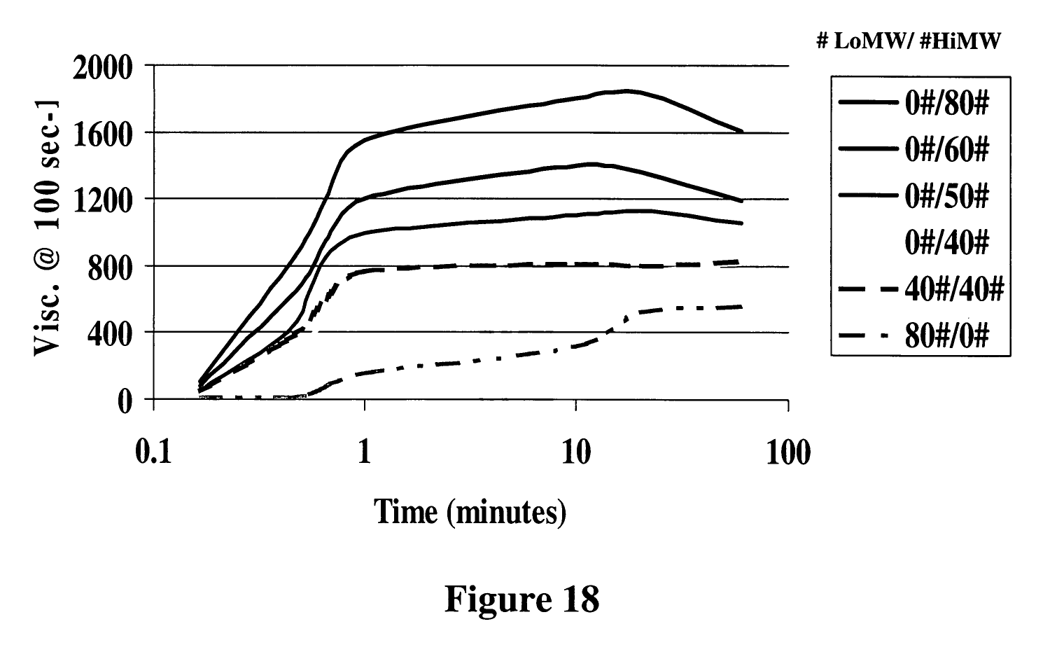

FIG. 19 shows the cumulative pump time, friction pressure, and shear rate of a typical fracturing process. The figure also shows the ideal viscosity profile for the fluid. Ideally, the fluid will have a low initial viscosity to facilitate pumping, and a high final viscosity to promote proppant transport in the fractured formation.

### Example 20

### Application of Multimodal Polymer Mixtures as Fracturing Fluids

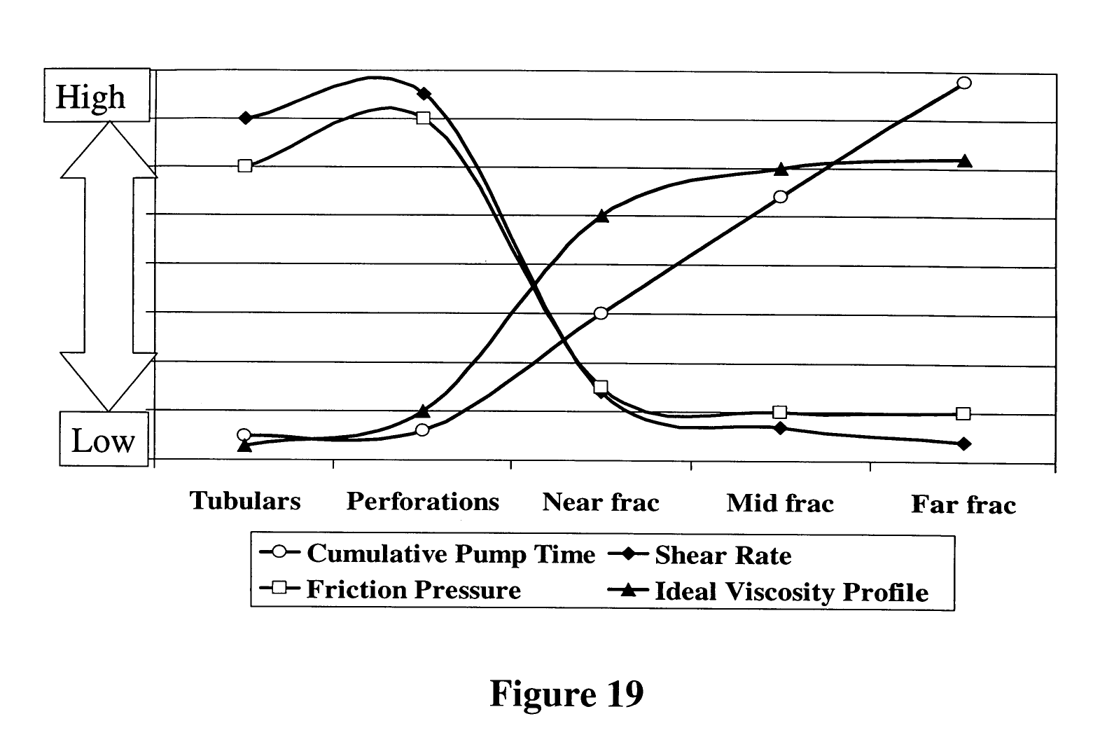

FIG. 20 illustrates the usefulness of a bimodal polymer mixture as a fracturing fluid. The figure also illustrates the behavior of monomodal low molecular weight guar polymer, and monomodal high molecular weight guar polymer for comparison.

The bimodal mixture nearly matches the ideal viscosity profile, providing low initial viscosity during pumping, and high final viscosity to promote residence in the formation and delivery of proppant. This behavior could be of particular benefit in coiled tubing applications, where the tubulars have a small diameter and friction pressures can be a limiting factor.

The monomodal low molecular weight guar composition fails to achieve an adequate final viscosity. The monomodal low molecular weight guar composition has an excessively high initial viscosity, making the delivery of the fluid into the formation more difficult.

### Example 21

### Determination of the Molecular Weight for a Low Molecular Weight Guar and a High Molecular Weight Guar

A sample of low molecular weight guar was received from Hercules Incorporated/Aqualon Division. The sample from Aqualon, was labeled as “Low Molecular Weight Guar” “2% Viscosity Range/130-190 cps” (additionally hand labeled “800 PPM Boron”). A study was undertaken to determine the molecular weight of the material. High Performance Liquid Chromatograph—Gel Permeation Chromatography (HPLC-GPC) was utilized to measure the molecular weight of the material. A reference sample of a standard high molecular weight guar, referred to as GW-4, was selected as a point of comparison.

The samples were prepared for analysis by first solvating the polymers in 100 milliliters of 0.05 Molar sodium nitrate. The polymer solutions were then stirred at 800 RPM and at 40° C. for a period of twenty-four hours in order to ensure sufficient hydration of the polymers. After solvation the solutions were ready for injection into the HPLC-GPC. The instrument consists of a Waters 2690 HPLC separation unit equipped with a Viscotek G600PWxL and GMPWxL separation columns and Viscotek T60 and LR40 detectors; the carrier eluent utilized is 0.05M sodium nitrate. Table 1 contains the data obtained for the Aqualon LMW guar and the GW-4 reference sample. The average molecular weight that was determined for the submitted LMW Guar was 270,000 daltons.

TABLE 1
Molecular Weight
Molecular Weight Determination via HPLC-GPC

| | Concentration | Average Molecular Weight |
|---|---|---|
| Sample | (mg/mL) | (daltons) |
| Aqualon LowMW Guar | 0.417 | 270,000 |
| GW-4 std. high MW Guar | 0.489 | 2,300,000 |

Data for each lot of sample display in Table 1 is an average of triplicate injections.

High Performance Liquid Chromatography, occasionally referred to as High Pressure Liquid Chromatography in older texts, Gel Permeation Chromatography is a separation and detection technique. A sample, either liquid or a solid dissolved in a suitable solvent, is injected through micro-porous columns under pressure. The sample separates based on the affinity of the chemical components for the eluent/column and its physical size as it passes through the column packing material. The separated sample then passes through a series of detectors where the analysis is done, in this way the separated components of a sample can be analyzed individually.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and/or and in the steps or in the sequence of steps of the methods described herein without departing from the concept and scope of the invention. More specifically, it will be apparent that certain agents which are chemically related may be substituted for the agents described herein while the same or similar results would be achieved. All such similar substitutes and modifications apparent to those skilled in the art are deemed to be within the scope and concept of the invention.

1. A well treatment fluid comprising:
a liquid;
a polymer mixture soluble in the liquid, the mixture having a multi-modal molecular weight distribution; and
a crosslinking agent capable of increasing the viscosity of the well treatment fluid by crosslinking the polymer.

2. The well treatment fluid of claim 1, wherein the liquid comprises water.

3. The well treatment fluid of claim 1, wherein the liquid is a mixture of water and an alcohol.

4. The well treatment fluid of claim 1, wherein the multi-modal molecular weight distribution is a bimodal molecular weight distribution.

5. The well treatment fluid of claim 1, wherein the multi-modal molecular weight distribution is a trimodal molecular weight distribution.

6. The well treatment fluid of claim 1, wherein the polymer mixture comprises a polysaccharide.

7. The well treatment fluid of claim 1, wherein the polymer mixture comprises guar, hydroxypropyl guar, cationic guar, carboxymethyl guar, carboxyethyl guar, carboxypropyl guar, carboxymethyl hydroxypropyl guar, carboxymethyl hydroxyethyl guar, carboxymethyl methyl guar, salts thereof, or mixtures thereof.

8. The well treatment fluid of claim 1, wherein the crosslinking agent is an antimony crosslinking agent.

9. The well treatment fluid of claim 8, wherein the antimony crosslinking agent is an alkali pyroantimonate or potassium pyroantimonate.

10. The well treatment fluid of claim 1, wherein the crosslinking agent is a boron crosslinking agent.

11. The well treatment fluid of claim 10, wherein the boron crosslinking agent is boric acid, boric oxide, alkali metal borate, alkaline earth metal borate, organoborate or a mixture thereof.

12. The well treatment fluid of claim 10, wherein the boron crosslinking agent is probertite, ulexite, nobleite, growerite, frolovite, colemanite, meyerhofferite, inyoite, priceite, tertschite, ginorite, pinnoite, paternoite, kurnakovite, inderite, preobrazhenskite, hydroboracite, inderborite, kaliborite, or veatchite.

13. The well treatment fluid of claim 1, further comprising a proppant.

14. The well treatment fluid of claim 1, further comprising a breaking agent.

15. The well treatment fluid of claim 1, further comprising a clay stabilizer.

16. The well treatment fluid of claim 1, having a ratio of polymer mixture to liquid of up to about 200 pounds per 1,000 gallons (up to about 24 kg per 1,000 liters).

17. The well treatment fluid of claim 1, having a ratio of polymer mixture to liquid of up to about 100 pounds per 1,000 gallons (up to about 12 kg per 1,000 liters).

18. The well treatment fluid of claim 1, having a ratio of polymer mixture to liquid of about 10 pounds per 1,000 gallons (about 1.2 kg per 1,000 liters) to about 80 pounds per 1,000 gallons (about 9.6 kg per 1,000 liters).

19. The well treatment fluid of claim 1, having a ratio of polymer mixture to liquid of at least about 20 pounds per 1,000 gallons (at least about 2.4 kg per 1,000 liters).

20. The well treatment fluid of claim 1, wherein the pH of the well treatment fluid is about 3 to about 6.

21. The well treatment fluid of claim 1, wherein the pH of the well treatment fluid is at least about 7.

22. The well treatment fluid of claim 1, wherein the pH of the well treatment fluid is about 8 to about 12.

23. The well treatment fluid of claim 1, wherein the viscosity of the well treatment fluid is at least about 200 cP at 40 sec⁻¹.

24. A method of treating a subterranean formation, the method comprising:
obtaining a fracturing fluid comprising a liquid, a polymer soluble in the liquid, the mixture having a multi-modal molecular weight distribution, and a crosslinking agent capable of increasing the viscosity of the fracturing fluid by crosslinking the polymer; and
injecting the fracturing fluid into a bore hole to contact at least a portion of the subterranean formation.

25. The method of claim 24, wherein the liquid comprises water.

26. The method of claim 24, wherein the multi-modal molecular weight distribution is a bimodal molecular weight distribution.

27. The method of claim 24, wherein the multi-modal molecular weight distribution is a trimodal molecular weight distribution.

28. The method of claim 24, wherein the polymer is guar, hydroxypropyl guar, cationic guar, carboxymethyl guar, carboxyethyl guar, carboxypropyl guar, carboxymethyl hydroxypropyl guar, carboxymethyl hydroxyethyl guar, carboxymethyl methyl guar, salts thereof, or mixtures thereof.

29. The method of claim 24, wherein the crosslinking agent is an antimony crosslinking agent.

30. The method of claim 29, wherein the antimony crosslinking agent is an alkali pyroantimonate or potassium pyroantimonate.

31. The method of claim 24, wherein the crosslinking agent is a boron crosslinking agent.

32. The method of claim 31, wherein the boron crosslinking agent is boric acid, boric oxide, alkali metal borate, alkaline earth metal borate, organoborate, or a mixture thereof.

33. The method of claim 31, wherein the boron crosslinking agent is probertite, ulexite, nobleite, growerite, frolovite, colemanite, meyerhofferite, inyoite, priceite, tertschite, ginorite, pinnoite, patemoite, kumakovite, inderite, preobrazhenskite, hydroboracite, inderborite, kaliborite, or veatchite.

34. The method of claim 24, wherein the fluid further comprises a proppant.

35. The method of claim 24, wherein the fluid further comprises a breaking agent.

36. The method of claim 24, wherein the fluid further comprises a clay stabilizer.

37. (canceled)

38. (canceled)

39. The method of claim 24, wherein the fracturing fluid further comprises a proppant.

40. The method of claim 24, wherein the pH of the fracturing fluid is about 8 to about 12.

41. The method of claim 24, wherein the viscosity of the fracturing fluid is at least about 200 cP at 40 sec⁻¹.

42. The method of claim 24, wherein the fracturing fluid is injected via coiled tubing into the bore hole to contact at least a portion of the subterranean formation.
